(19) United States
(12) Patent Application Publication
(10) Pub. No.: US 2025/0171662 A1
(43) Pub. Date: May 29, 2025

(54) THERMOFORMED SHEET

(71) Applicant: 3M INNOVATIVE PROPERTIES COMPANY, St. Paul, MN (US)

(72) Inventor: Ken Egashira, Kanagawa (JP)

(21) Appl. No.: 18/842,068

(22) PCT Filed: Feb. 27, 2023
(86) PCT No.: PCT/IB2023/051815

§ 371 Date: Aug. 28, 2024

(30) Foreign Application Priority Data
Feb. 28, 2022 (JP) 2022-029785

(51) Int. Cl. C09J 7/38; C08K 3/04; C09J 133/06; C09J 175/04

(52) U.S. Cl. CPC C09J 7/385; C08K 3/04; C09J 133/064; C09J 175/04; C08J 2333/10; C08J 2375/04

(57) ABSTRACT

The present disclosure provides a thermoformed sheet that can reduce or prevent peel and cut opening over time even when the thermoformed sheet is bonded to an adherend using a molding method involving heating. A thermoformed sheet of one embodiment of the present disclosure includes a first adhesive layer, a second adhesive layer, and a surface layer in this order. The first adhesive layer contains 65 mass % or greater, in terms of solid content ratio, of an acyclic aliphatic isocyanate polymer blocked with a blocking agent that starts to dissociate at lower than 160° C. and has a thickness of 0.5 micrometers or greater and 13 micrometers or less. The thermoformed sheet has a tensile strength of 3 N/50 mm or greater and 240 N/50 mm or less when stretched to 200% at 95° C.

### BACKGROUND

In recent years, technology is known in which a thermoformed sheet having performance such as decorative properties is bonded to an adherend using a molding method involving heating.

Patent Document 1 (JP 2012-111043 A) describes a multilayer decorative film for use in vacuum molding, including a hard coat layer (A), a base film layer (B), a design layer (C), and an adhesive layer (D), wherein an adhesive layer (D) has at least one solid surface-deactivating polyisocyanate (D1) having a melting point of 40° C. or higher and having a particle size of 200 um or less, and at least one isocyanate-reactive polymer (D2).

Patent Document 2 (JP 2018-512477 T) includes a decoration sheet for vacuum thermoforming, including an adhesive layer, a substrate layer formed on an upper portion of the adhesive layer, a printed layer formed on an upper portion of the substrate layer, and a transparent substrate layer formed on an upper portion of the printed layer, wherein the adhesive layer contains a polyurethane polymer and an acrylic polymer, and is formed of a vacuum thermoforming adhesive composition having a difference between a melting temperature and a cross-linking temperature of from 30° C. to 60° C.

Patent Document 3 (JP 2014-031003 A) describes a decorative molding film including at least two layers or more including an adhesive layer (A) and a layer (B) layered on the adhesive layer (A), wherein the adhesive layer (A) contains an isocyanate group having an olefin-based resin and an NCO content from 0.01 to 1.6 parts by mass, and a resin contained in the layer (B) has a hydroxy group.

### SUMMARY

### Technical Problem

When a thermoformed sheet is bonded to an adherend by using a molding method involving heating (for example, a dual vacuum thermoforming method), the sheet is applied to the adherend in a stretched state. As a result, since elongation stress is applied to the stretched part of the sheet, if the sheet is peeled off from an end thereof over time or the stretched part of the sheet is damaged and a cut is formed, there is a risk that the cut may be opened over time.

The present disclosure provides a thermoformed sheet that can reduce or prevent peel and cut opening over time even when the thermoformed sheet is bonded to an adherend using a molding method involving heating.

### Solution to Problem

According to one embodiment of the present disclosure, there is provided a thermoformed sheet including a first adhesive layer, a second adhesive layer, and a surface layer in this order, wherein the first adhesive layer contains approximately 65 mass % or greater, in terms of solid content ratio, of an acyclic aliphatic isocyanate polymer blocked with a blocking agent that starts to dissociate at lower than approximately 160° C., and has a thickness of approximately 0.5 micrometers or greater and approximately 13 micrometers or less, and the thermoformed sheet has a tensile strength of approximately 3 N/50 mm or greater and approximately 240 N/50 mm or less when stretched to 200% at 95° C.

According to another embodiment of the present disclosure, an article having the thermoformed sheet described above adhered to a supporting member is provided.

The present disclosure can provide a thermoformed sheet that can reduce or prevent peel and cut opening over time even when the thermoformed sheet is bonded to an adherend using a molding method involving heating.

The above description should not be construed as disclosing all embodiments of the present invention and all advantages relating to the present invention.

### BRIEF DESCRIPTION OF DRAWINGS

FIG. 1 is a schematic cross-sectional view of a thermoformed sheet of an embodiment.

FIG. 2 is a diagram illustrating a method of applying a thermoformed sheet to a supporting member using a Dual Vacuum Thermoforming (DVT) method to form an article.

FIG. 3A is a schematic cross-sectional view of a vacuum and pressure forming machine before stretching in DVT moldability evaluation in the examples.

FIG. 3B is a top view illustrating an arrangement position of a supporting member (adherend) in DVT moldability evaluation in the examples.

FIG. 3C is a schematic cross-sectional view of a vacuum and pressure forming machine after stretching in DVT moldability evaluation in the examples.

FIG. 4(a) is a photograph showing cuts in a lattice-like manner provided on a test piece in a heat shrinkage test in the examples, and FIG. 4(b) is a photograph showing cuts in a lattice-like manner provided on a test piece in a heat shrinkage test in the comparative examples.

### DESCRIPTION OF EXEMPLARY EMBODIMENTS

Hereinafter, representative embodiments of the present invention will be described in more detail with reference to the drawing, as necessary, for the purpose of illustration, but the present invention is not limited to these embodiments. Regarding the reference numbers in the drawings, constituents labeled with similar numbers across different drawings are similar or corresponding constituents.

In the present disclosure, the term “in this order”, for example used in “thermoformed sheet including a second adhesive layer and a surface layer in the order”, means that, when two components that are the second adhesive layer and the surface layer are focused, the thermoformed sheet contains these components in this order, and another layer such as a decorative layer may be interposed between these components.

In the present disclosure, the term “on”, for example used in “a surface layer is disposed on the second adhesive layer” means that the surface layer is disposed directly on the upper side of the second adhesive layer, or that the surface layer is indirectly disposed on the upper side of the second adhesive layer via other layers.

In the present disclosure, the term “under”, for example used in “a decorative layer is disposed under the surface layer” means that the decorative layer is disposed directly on the lower side of the surface layer, or that the decorative layer is indirectly disposed on the lower side of the surface layer via other layers.

In the present disclosure, the term “substantially” means that a variation caused by a production error or the like is included, and is intended to allow a variation of approximately ±20%.

In the present disclosure, “transparent” refers to an average transmittance in a visible light region (wavelength from 400 nm to 700 nm) measured in accordance with JIS K 7375 of approximately 80% or greater, and the average transmittance may be desirably approximately 85% or greater, or approximately 90% or greater. An upper limit of the average transmittance is not particularly limited, and can be, for example, approximately less than 100%, approximately 99% or less, or approximately 98% or less.

In the present disclosure, the term “translucent” refers to an average transmittance in a visible light region (wavelength from 400 nm to 700 nm) measured in accordance with JIS K 7375 of approximately less than 80%, and the average transmittance may be desirably approximately 75% or less, and “translucent” is intended to mean that an underlying layer or the like is not completely hidden.

In the present disclosure, the term “(meth)acrylic” refers to acrylic or methacrylic, and the term “(meth)acrylate” refers to acrylate or methacrylate.

In the present disclosure, the term “sheet” encompasses members referred to as “films”.

Hereinafter, the thermoformed sheet of the present disclosure will be described with reference to the drawings as necessary.

The thermoformed sheet of one embodiment includes a first adhesive layer, a second adhesive layer, and a surface layer in this order. The first adhesive layer contains approximately 65 mass % or greater, in terms of solid content ratio, of an acyclic aliphatic isocyanate polymer blocked with a blocking agent that starts to dissociate at approximately lower than 160° C., and has a thickness of approximately 0.5 micrometers or greater and approximately 13 micrometers or less. The thermoformed sheet of this embodiment has a tensile strength of approximately 3 N/50 mm or greater and approximately 240 N/50 mm or less when stretched to 200% at 95° C.

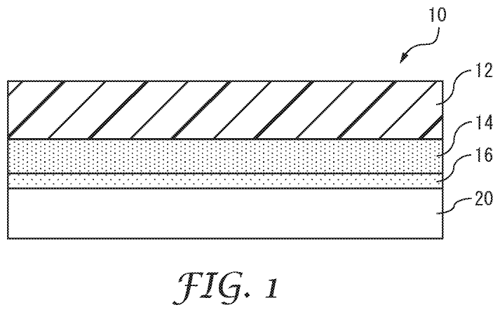

A schematic cross-sectional view of a thermoformed sheet 10 of an embodiment is illustrated in FIG. 1. The thermoformed sheet 10 includes a first adhesive layer 16, a second adhesive layer 14, and a surface layer 12 on a release liner 20. Note that the release liner is an optional component, and the thermoformed sheet of the present disclosure may include a release liner or may include no release liner.

Hereinafter, for the purpose of illustrating representative embodiments of the present disclosure, details of each component will be described with some reference signs omitted.

The first adhesive layer of the present disclosure contains approximately 65 mass % or greater, in terms of solid content ratio, of an acyclic aliphatic isocyanate polymer blocked with a blocking agent that starts to dissociate at approximately lower than 160° C., and has a thickness of approximately 0.5 micrometers or greater and approximately 13 micrometers or less. The first adhesive layer is typically a layer applied to an adherend, such as a supporting member of an article which will be described below. The second adhesive layer of the present disclosure can be, for example, an adhesive layer used in a known thermoformed sheet, unlike the first adhesive layer. The present inventors have found that peel or cut opening over time in the thermoformed sheet after application to an adherend (simply referred to as “opening” in some cases) cannot be improved simply by blending the acyclic aliphatic isocyanate polymer described above in the adhesive layer used in a known thermoformed sheet, but that combined use of the second adhesive layer and the above-mentioned first adhesive layer can suitably improve peel and opening over time. Such peel and opening are more likely to occur under high temperatures, but the thermoformed sheet of the present disclosure can exhibit an effect of reducing or preventing peel and opening under high temperatures. The “high temperatures” can be, for example, approximately 50° C. or higher, approximately 70° C. or higher, approximately 90° C. or higher, or approximately 95° C. or higher, and approximately 120° C. or lower, approximately 110° C. or lower, or approximately 100° C. or lower.

The blocking agent is not particularly limited as long as it is a blocking agent that starts to dissociate at approximately lower than 160° C. The thermoformed sheet is generally stored in a warehouse or the like before bonded to the adherend. Therefore, from the perspective of maintaining the reaction of the acyclic aliphatic isocyanate polymer during storage, a lower limit of a dissociation starting temperature of the blocking agent is preferably approximately 50° C. or higher, approximately 70° C. or higher, approximately 90° C. or higher, approximately 100° C. or higher, or approximately 110° C. or higher. On the other hand, during thermoforming, it is necessary to dissociate the blocking agent by heating during molding to proceed with the reaction of the acyclic aliphatic isocyanate polymer. Therefore, from the perspective of reaction progression of the acyclic aliphatic isocyanate polymer during thermoforming, an upper limit of the dissociation starting temperature of the blocking agent is preferably approximately 150° C. or lower, approximately 140° C. or lower, approximately lower than 140° C., approximately 130° C. or lower, or approximately 120° C. or lower. The blocking agent can be used alone, or two or more of the blocking agents can be used in combination.

Examples of the blocking agent can include alcohols such as methanol, ethanol, isopropanol, n-butanol, heptanol, hexanol, 2-ethoxyhexanol, cyclohexanol, octanol, isononyl alcohol, stearyl alcohol, benzyl alcohol, 2-ethoxyethanol, methyl lactate, ethyl lactate, amyl lactate, ethylene glycol monomethyl ether, ethylene glycol monoethyl ether, ethylene glycol monobutyl ether, ethylene glycol monomethyl ether, ethylene glycol monoethyl ether, propylene glycol monomethyl ether, propylene glycol monoethyl ether, propylene glycol monopropyl ether, diethylene glycol monoethyl ether, diethylene glycol monobutyl ether), triethylene glycol monoethyl ether, N,N-dimethylaminoethanol, N,N-diethylaminoethanol, and N,N-dibutylaminoethanol; phenols such as phenol, ethylphenol, propylphenol, butylphenol, octylphenol, nonylphenol, nitrophenol, chlorophenol, o-cresol, m-cresol, p-cresol, and xylenol; lactams such as α-pyrrolidone, β-butyrolactam, β-propiolactam, γ-butyrolactam, and δ-valerolactam; oximes such as acetone oxime, methyl ethyl ketone oxime, methyl isobutyl ketone oxime, diethyl ketone oxime; cyclohexanone oxime, acetophenone oxime, and benzophenone oxime; pyrazoles such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; mercaptans such as butyl mercaptan, hexyl mercaptan, dodecyl mercaptan, and benzenethiol; active methylene compounds such as diethyl malonate, acetoacetic acid ester, dinitrile malonic acid, acetylacetone, methylenedisulfone, dibenzoylmethane, dipivaloylmethane, and acetonedicarboxylic acid diester; amines such as dibutylamine, diisopropylamine, di-tert-butylamine, di(2-ethylhexyl)amine, dicyclohexylamine, benzylamine, diphenylamine, aniline, and carbazole; imidazoles such as imidazole and 2-ethylimidazole; imines such as methyleneimine, ethyleneimine, polyethyleneimine, and propyleneimine; acid amides such as acetanilide, (meth)acrylamide, acetic acid amide, and dimer acid amide; acid imides such as succinimide, maleic acid imide, and phthalate imide; and urea compounds such as urea, thiourea and ethylene urea. Among these, from the perspective of the reaction progress of the acyclic aliphatic isocyanate polymer during storage and thermoforming, methyl ethyl ketone oxide, 3,5-dimethylpyrazole, and diethyl malonate are preferable, and 3,5-dimethylpyrazole is more preferable.

The acyclic aliphatic isocyanate polymer of the present disclosure is a polymer in which a polymer of an acyclic aliphatic isocyanate compound is blocked with the blocking agent described above. The acyclic aliphatic isocyanate polymer can be used alone, or two or more of acyclic aliphatic isocyanate polymers can be used in combination.

Examples of the acyclic aliphatic isocyanate compound can include 1,4-tetramethylene diisocyanate, 1,5-pentamethylene diisocyanate, 1,6-hexamethylene diisocyanate, 2,2,4-trimethyl-1,6-hexamethylene diisocyanate, 1,3,6-hexamethylene triisosia Net, lysine diisocyanate, and modified bodies thereof (e.g., isocyanurate, biuret, trimer, ethylene glycol adduct, propylene glycol adduct, trimethylolpropane adduct, ethanolamine adduct, allophanate, uretdione, polyester polyol adduct, polyether polyol adduct, polyamide adduct, and polyamine adduct). Among these, from the perspective of adhesive force to the adherend (peel prevention properties), opening resistance, and the like, at least one selected from the group consisting of 1,6-hexamethylene diisocyanate (simply referred to as “hexamethylene diisocyanate” or “HDI” in some cases) and modified compounds thereof (e.g., biuret, trimer, trimethylolpropane adduct, allophanate, and uretdione) is preferable. The acyclic aliphatic isocyanate compound can be used alone, or two or more of acyclic aliphatic isocyanate polymers can be used in combination.

The first adhesive layer of the present disclosure contains approximately 65 mass % or greater, in terms of solid content ratio, of an acyclic aliphatic isocyanate polymer blocked with a blocking agent that starts to dissociate at approximately lower than 160° C. From the perspective of adhesive force to the adherend (peel prevention properties), opening resistance, and the like, an amount of the polymer blended in the first adhesive layer is approximately 70 mass % or greater, approximately 75 mass % or greater, approximately 80 mass % or greater, approximately 85 mass % or greater, approximately 90 mass % or greater, or approximately 95 mass % or greater in terms of solid content ratio. An upper limit of the amount of the polymer blended in the first adhesive layer is not particularly limited, and can be approximately 100 mass % or less, or approximately less than 100 mass %.

The first adhesive layer of the present disclosure has a thickness of approximately 0.5 micrometers or greater and approximately 13 micrometers or less. When the thickness of the first adhesive layer is within this range, it is possible to provide excellent adhesive force to the adherend (peel prevention properties) and opening resistance, and to reduce or prevent the appearance failure associated with the air bubbles and the like. In the case of a configuration in which only the first adhesive layer is used without using the second adhesive layer, there is a risk that the first adhesive layer having a thickness of approximately 13 micrometers or less cannot provide good adhesive force to the adherend, or there is a risk that the first adhesive layer having a thickness of approximately more than 13 micrometers causes an increase in rate of gas generated due to dissociation of the blocking agent, which may result in an appearance defect such as air bubbles associated with the generated gas. The thermoformed sheet of the present disclosure makes it possible to reduce or prevent appearance defects such as air bubbles, while improving the adhesive force to the adherend (peel prevention properties) and the opening resistance by employing, as the adhesive layer, a two-layer adhesive layer having a specific first adhesive layer.

The thickness of the first adhesive layer can be, for example, approximately 0.7 micrometers or greater, approximately 1.0 micrometers or greater, approximately 2.0 micrometers or greater, approximately 3.0 micrometers or greater, approximately 4.0 micrometers or greater, or approximately 5.0 micrometers or greater, and can be approximately 12 micrometers or less, approximately 11 micrometers or less, approximately 10 micrometers or less, approximately 9.0 micrometers or less, or approximately 8.0 micrometers or less.

Here, the thickness of the adhesive layer in the present disclosure can be measured, for example, using the cross-sectional measurement method described in JP 2018-004789 A. Specifically, the thermoformed sheet having a laminate configuration is embedded with an epoxy resin to prepare a sample piece. This sample piece is sliced to a thickness of 5 micrometers using a microtome. Thereafter, by observing the cross section caused by the slice using a microscope, the thickness of each layer included in the thermoformed sheet can be measured.

As optional components, the first adhesive layer of the present disclosure can contain, for example, tackifying resins, cross-linking agents, fillers such as electrically conductive fillers and thermally conductive fillers, silane coupling agents, plasticizers, thickeners, pigments, dyes, flame retardants, antioxidants, UV absorbing agents, and stabilizers. These optional components can be used alone, or in combination of two or more types.

The first adhesive layer can be formed using an acyclic aliphatic isocyanate polymer and a solvent, as well as, as necessary, a first adhesive composition containing the optional components described above. Specifically, a first adhesive composition can be coated on the second adhesive layer, and dried, solidified or cured to form the first adhesive layer. Alternatively, a first adhesive composition can be coated on another release liner and dried, solidified, or cured to form a first adhesive layer, and then the first adhesive layer can be heat-laminated on second adhesive layer. For example, the first adhesive layer can be formed by coating the first adhesive composition to the second adhesive layer or the release liner through knife coating, bar coating, blade coating, doctor coating, roll coating, or cast coating and, as necessary, heating and drying, solidifying, or curing the first adhesive composition. The release liner may have a surface subjected to release treatment with silicone or the like.

The first adhesive layer generally forms a flat adhesive surface, but may also form an adhesive surface with recesses and protrusions. The adhesive surface with recesses and protrusions include an adhesive surface of the first adhesive layer, in which the protrusions containing the adhesive and the recesses surrounding the protrusions are formed, and when the adhesive surface is attached to an adherend, a communicating passage is formed between the adherend surface and the adhesive surface, the communicating passage being defined by the recesses and being in communication with the external space. An example of the method for forming the adhesive surface with recesses and protrusions will be described below.

A release liner with a release surface including a predetermined recess-and-protrusion structure is prepared. The first adhesive composition is coated to the release surface of the release liner, and as necessary, heated to form the first adhesive layer. By this, the relief structure (negative structure) of the release liner is transferred to the face that adjoins the release liner of the first adhesive layer (this serves as the adhesion face in the thermoformed sheet), and an adhesive surface with recesses and protrusions having the prescribed structure (positive structure) is formed on the adhesion face. As described above, the recesses and protrusions of the adhesive surface are designed in advance to include a groove that allows formation of the communicating passage when the protrusions adhere to the adherend. Such recesses and protrusions may be formed only in the first adhesive layer, or may be formed across the second adhesive layer which will be described later from the first adhesive layer.

For the groove of the first adhesive layer, as long as air bubbles are prevented from remaining when the thermoformed sheet is bonded to a supporting member as an adherend by a thermoforming method (for example, DVT method), the groove having a consistent shape may be arranged at the adhesive surface in accordance with a regular pattern to form a regularly-patterned groove, or the groove having an indeterminate shape may be arranged to form an irregularly-patterned groove. In a case where multiple grooves are formed to be disposed substantially parallel to each other, the interval at which the grooves are disposed is preferably from approximately 10 to approximately 2,000 micrometers. The depth of the groove is typically approximately 10 micrometers or greater and approximately 100 micrometers or less. The depth of the groove is intended to be a distance from the adhesive surface to the bottom of the groove measured in the thickness direction of the thermoformed sheet. The bottom of the groove may be present at any location of the thermoformed sheet, e.g. may be present in the first adhesive layer, may be present in the second adhesive layer beyond the first adhesive layer, or may be present in another layer (e.g., decorative layer or surface layer) disposed on the second adhesive layer beyond the first adhesive layer and the second adhesive layer. From the perspective of preventing air bubbles from remaining, the bottom of the grooves is preferably present in the first adhesive layer or in the second adhesive layer, and more preferably in the second adhesive layer. The shape of the groove is also not particularly limited, as long as the effect of the present invention is not impaired. For example, the shape of the groove may be substantially rectangular (including trapezoidal), substantially semi-circular, or substantially semi-elliptical at a cross-section of the groove in a direction perpendicular to the adhesive surface.

The thermoformed sheet of the present disclosure includes a second adhesive layer. The second adhesive layer may be directly applied to the first adhesive layer and the surface layer or may be indirectly applied thereto through another layer (e.g., decorative layer). Another layer may be applied to the entire surface of the second adhesive layer or may be partially applied. From the perspective of the adhesive force to the adherend (peel prevention properties) and opening resistance, the second adhesive layer is preferably applied directly to the first adhesive layer.

The raw material of the second adhesive layer is not particularly limited and, for example, a typically used adhesive agent can be used, such as a solvent, emulsion, pressure-sensitive, heat-sensitive, thermosetting, or ultraviolet-curable adhesive agent of (meth)acrylic, polyolefin, polyurethane, polyester, or rubber. The pressure-sensitive adhesive agent and the heat-sensitive adhesive agent may be crosslinked by thermal crosslinking or radiation (e.g., electron beams or ultraviolet light) using a crosslinking agent.

Among such raw materials, for example, from the perspective of ease in bonding to an adherend, a pressure-sensitive adhesive agent or a heat-sensitive adhesive agent is preferred, and from the perspective of capability of utilizing heat of an infrared heater during vacuum molding or vacuum compressed air molding, a heat-sensitive adhesive agent is more preferred. In the present disclosure, the term “pressure-sensitive adhesive agent” refers to an adhesive agent with permanent adhesiveness at room temperature (e.g., approximately 20° C.) that adheres to various surfaces with light pressure and does not exhibit a phase change (from liquid to solid). In the present disclosure, “heat-sensitive adhesive agent” refers to a raw material that does not exhibit adhesiveness (tackiness) at room temperature but exhibits tackiness at high temperatures, and includes heat-activated adhesive agents and hot melt adhesive agents. A heat-activated adhesive agent is also called as delayed-tack heat-sensitive adhesive agent and causes tackiness by being activated when heated, and the tackiness remains for a while even after the heat source is removed. The hot melt adhesive agent exhibits tackiness by being melted or softened by heating and rapidly solidifies and loses the tackiness when the heat source is removed. Typically, the heat-sensitive adhesive agent has a glass transition temperature (Tg) or a melting point (Tm) that is higher than room temperature. In a case where a temperature is higher than the Tg or Tm, a storage modulus of the heat-sensitive adhesive agent is reduced, and thus the heat-sensitive adhesive agent exhibits tackiness. The Tg and Tm of the heat-sensitive adhesive agent is measured by differential scanning calorimetry (DSC).

The raw material of the pressure-sensitive adhesive agent is not particularly limited, and for example, (meth)acrylic polymers, natural rubbers, synthetic rubbers, polyester-based polymers, polyether-based polymers, polyurethane-based polymers, silicone-based polymers, or other polymers can be used. Among these, a pressure-sensitive adhesive agent of (meth)acrylic polymer is preferred because of excellent transparency, weather resistance, and adhesiveness.

The raw material of the heat-sensitive adhesive agent is not particularly limited, and, from the perspective of the adhesive force to the adherend (peel prevention properties) and opening resistance, (meth)acrylic heat-sensitive adhesive agents and polyurethane-based heat-sensitive adhesive agents are preferable.

Examples of the (meth)acrylic heat-sensitive adhesive agent includes a thermoplastic resin (hereinafter also referred to as “acrylic blend thermoplastic resin”) including a carboxy group-containing (meth)acrylic polymer and an amino group-containing (meth)acrylic polymer (hereinafter also collectively referred to simply as “(meth)acrylic polymer”), These thermoplastic resins can be used alone, or two or more thereof can be used in combination.

The acrylic blend thermoplastic resin includes a polymer blend of the carboxy group-containing (meth)acrylic polymer and the amino group-containing (meth)acrylic polymer. A non-covalent interaction between the carboxy group-containing (meth)acrylic polymer and the amino group-containing (meth)acrylic polymer imparts elongation characteristics and strength to the second adhesive layer. As a result, the thermoformed sheet has high stretchability suitable for the DVT method, such as stretchability that enables stretching to 200% or greater in terms of an area ratio when the area of the thermoformed sheet before stretching is taken as 100%. Furthermore, the thermoformed sheet can maintain adhesion state without breaking or peeling and can maintain appearance of paint color or the like even after the thermoformed sheet is allowed to stand in a high temperature environment for a long time after stretching and adhering. The carboxy group-containing (meth)acrylic polymer can be formed by copolymerization of a monoethylenically unsaturated monomer and a carboxy group-containing unsaturated monomer. The amino group-containing (meth)acrylic polymer can be formed by copolymerization of a monoethylenically unsaturated monomer and an amino group-containing unsaturated monomer.

The monoethylenically unsaturated monomer, which serves as a main component for a (meth)acrylic polymer, typically includes acylates represented by the formula CH₂═CR¹COOR² (in the formula, R¹ is hydrogen or a methyl group, and R² is a linear, branched, or cyclic alkyl group, a phenyl group, an alkoxyalkyl group, a phenoxyalkyl group, a hydroxyalkyl group, or a cyclic ether group), and additionally, aromatic vinyl monomers such as styrene, α-methylstyrene, and vinyl toluene, vinyl esters such as vinyl acetate, and unsaturated nitriles such as acrylonitrile and methacrylonitrile. Examples of the monoethylenically unsaturated monomer represented by CH₂═CR¹COOR² can include linear alkyl (meth)acrylates such as methyl (meth)acrylate, ethyl (meth)acrylate, n-butyl (meth)acrylate, n-hexyl (meth)acrylate, n-decyl (meth)acrylate, and n-dodecyl (meth)acrylate; branched alkyl (meth)acrylates such as isoamyl (meth)acrylate, 2-ethylhexyl (meth)acrylate, isooctyl (meth)acrylate, and isononyl (meth)acrylate; alicyclic (meth)acrylates such as cyclohexyl (meth)acrylate and isobornyl (meth)acrylate; phenyl (meth)acrylates; alkoxyalkyl (meth)acrylates such as methoxypropyl (meth)acrylate and 2-methoxybutyl (meth)acrylate; phenoxyalkyl (meth)acrylates such as phenoxyethyl (meth)acrylate; hydroxyalkyl (meth)acrylates such as 2-hydroxyethyl (meth)acrylate, 2-hydroxypropyl (meth)acrylate, and 4-hydroxybutyl (meth)acrylate; and cyclic ether-containing (meth)acrylates such as glycidyl (meth)acrylate and tetrahydrofurfuryl (meth)acrylate. One or more types of monoethylenically unsaturated monomers can be used as the monoethylenically unsaturated monomer, for example, for the purpose of achieving desired glass transition temperature, tensile strength, elongation characteristics, and the like.

Examples of the carboxy group-containing unsaturated monomer include unsaturated monocarboxylic acids such as acrylic acid, methacrylic acid, and crotonic acid; unsaturated dicarboxylic acids such as itaconic acid, fumaric acid, citraconic acid, and maleic acid; ω-carboxy polycaprolactone monoacrylate, phthalic acid monohydroxyethyl (meth)acrylate, β-carboxyethyl acrylate, 2-(meth)acryloyl oxyethyl succinate, and 2-(meth)acryloyl oxyethyl hexahydrophthalate. As the carboxy group-containing unsaturated monomer, one or more types of carboxy group-containing unsaturated monomers can be used, as necessary.

The carboxy group-containing (meth)acrylic polymer can be formed by copolymerization, for example, with the use of the monoethylenically unsaturated monomer in an amount of approximately 85 parts by mass or greater, approximately 90 parts by mass or greater, or approximately 92 parts by mass or greater and approximately 99.5 parts by mass or less, approximately 99 parts by mass or less, or approximately 98 parts by mass or less, and the carboxy group-containing monoethylenically unsaturated monomer in an amount of approximately 0.5 parts by mass or greater, approximately 1 part by mass or greater, or approximately 2 parts by mass or greater and approximately 15 parts by mass or less, approximately 10 parts by mass or less, or approximately 8 parts by mass or less.

Examples of the amino group-containing unsaturated monomer include dialkylaminoalkyl (meth)acrylates such as N,N-dimethylaminoethyl acrylate (DMAEA) and N,N-dimethylaminoethyl methacrylate (DMAEMA); dialkylaminoalkyl (meth)acrylamides such as N,N-dimethylaminopropyl acrylamide (DMAPAA) and N,N-dimethylaminopropyl methacrylamide; dialkylaminoalkyl vinyl ethers such as N,N-dimethylaminoethyl vinyl ether and N,N-diethylaminoethyl vinyl ether; and monomers having a tertiary amino group, e.g., vinyl monomers having a nitrogen-containing heterocycle such as vinylimidazole. As the amino group-containing unsaturated monomer, one or more types of amino group-containing unsaturated monomers can be used, as necessary.

The amino group-containing (meth)acrylic polymer can be formed by copolymerization, for example, with the use of the monoethylenically unsaturated monomer in a proportion of approximately 80 parts by mass or greater, approximately 85 parts by mass or greater, or approximately 90 parts by mass or greater and approximately 99.5 parts by mass or less, approximately 99 parts by mass or less, or approximately 97 parts by mass or less, and the amino group-containing unsaturated monomer in an amount of approximately 0.5 parts by mass or greater, approximately 1 part by mass or greater, or approximately 3 parts by mass or greater and approximately 20 parts by mass or less, approximately 15 parts by mass or less, or approximately 10 parts by mass or less.

The copolymerization is preferably performed by radical polymerization, and known polymerization methods can be utilized, such as solution polymerization, suspension polymerization, emulsion polymerization, and bulk polymerization. Examples of the initiator include organic peroxides such as benzoyl peroxide, lauroyl peroxide, and bis(4-tert-butylcyclohexyl) peroxydicarbonate, and azo-based polymerization initiators such as 2,2′-azobisisobutyronitile, 2,2′-azobis(2-methylbutyronitrile), dimethyl 2,2′-azobis(2-methylpropionate), 4,4′-azobis(4-cyanovaleric acid), and 2,2′-azobis(2,4-dimethylvaleronitrile) (AVN). An amount of the initiator used is approximately 0.01 parts by mass or greater or approximately 0.05 parts by mass or greater, and approximately 5 parts by mass or less or approximately 3 parts by mass or less, with respect to 100 parts by mass of the monomer mixture.

Preferably one of the carboxy group-containing (meth)acrylic polymer and the amino group-containing (meth)acrylic polymer has a glass transition temperature of 0° C. or higher, and the other thereof has a glass transition temperature of 0° C. or lower or lower than 0° C. In other words, in a case where the Tg of the carboxy group-containing (meth)acrylic polymer is 0° C. or higher, the Tg of the amino group-containing (meth)acrylic polymer is 0° C. or lower or lower than 0° C., and in a case where the Tg of the former is 0° C. or lower, the Tg of the latter is 0° C. or higher or higher than 0° C. Without wishing to be bound by any theory, it is believed that a (meth)acrylic polymer having a higher Tg imparts high tensile strength to the second adhesive layer, whereas a (meth)acrylic polymer having a lower Tg improves the elongation characteristics of the second adhesive layer. In some embodiments, the Tg of the (meth)acrylic polymer having higher Tg is approximately 5° C. or higher, approximately 20° C. or higher, or approximately 40° C. or higher, and the Tg of the (meth)acrylic polymer having lower Tg is approximately −5° C. or lower, approximately −20° C. or lower, or approximately −40° C. or lower.

For example, a (meth)acrylic polymer having a Tg of 0° C. or higher can be formed by copolymerization of, as a main component, a (meth)acrylic monomer, a homopolymer of which has a Tg of 0° C. or higher, if the (meth)acrylic monomer is subjected to homopolymerization. Such a (meth)acrylic polymer includes methyl methacrylate (MMA) and n-butyl methacrylate (BMA).

For example, a (meth)acrylic polymer having a Tg of 0° C. or lower can be formed by copolymerization of, as a main component, a component, a homopolymer of which has a Tg of 0° C. or lower, if the component is subjected to homopolymerization. Such a component includes ethyl acrylate (EA), n-butyl acrylate (BA), and 2-ethylhexyl acrylate (2EHA).

The glass transition temperature (Tg) of the carboxy group-containing (meth)acrylic polymer and the amino group-containing (meth)acrylic polymer can be determined according to the following Fox equation (Fox, T. G., Bull. Am. Phys. Soc., 1 (1956), p. 123), assuming that each of the polymers is copolymerized from n types of monomers.

$$\frac{1}{T g + 273.15} = {{\sum }^{n}}_{i = 1} ( \frac{{X}_{i}}{T {g}_{i} + 273.15} ) \qquad [ Equation 1 ]$$

In the equation, Tgᵢ is the glass transition temperature (° C.) of homopolymer of a component i, Xᵢ is the mass fraction of the monomer of the component i added during polymerization, and i is a natural number of 1 to n.

$${{\sum }^{n}}_{i = 1} {X}_{i} = 1 \qquad [ Equation 2 ]$$

In a case where the carboxy group-containing (meth)acrylic polymer or the amino group-containing (meth)acrylic polymer is a blend of two or more (meth)acrylic polymers that differ in weight average molecular weight, the Tg of the blend can be determined by dynamic viscoelasticity measurement. Specifically, the measurement is performed as follows. As a test piece, the film (thickness: approximately 50 μm) is prepared by coating a solution of the (meth)acrylic polymer blend onto a release liner and drying the coated liner. A dynamic viscoelastic spectrometer (from TA Instruments, model number: RSA III) is used to measure a loss tangent (tan δ) of the test piece under the conditions of temperature range from −20 to 160° C., Temp ramp mode, and frequency of 10 Hz. From the loss tangent measurement, the Tg of the polymer blend can be determined.

A weight average molecular weights of the carboxy group-containing (meth)acrylic polymer and amino group-containing (meth)acrylic polymer are not particularly limited, but can be, for example, approximately 1000 or greater, approximately 5000 or greater, or approximately 10000 or greater, and approximately 2000000 or less, approximately 1500000 or less, or approximately 1000000 or less. The weight average molecular weight in the present disclosure refers to a value determined by a GPC method calibrated with standard polystyrene.

In an embodiment, the weight average molecular weight of the (meth)acrylic polymer (low Tg (meth)acrylic polymer) having a glass transition temperature of 0° C. or lower or lower than 0° C. is approximately 100000 or greater, approximately 150000 or greater, or approximately 200000 or greater, and approximately 2000000 or less, approximately 1500000 or less, or approximately 1000000 or less.

In an embodiment, the weight average molecular weight of the (meth)acrylic polymer (high Tg (meth)acrylic polymer) having a glass transition temperature of 0° C. or higher or higher than 0° C. is approximately 1000 or greater, approximately 5000 or greater, or approximately 10000 or greater, and approximately 200000 or less, approximately 180000 or less, or approximately 150000 or less.

A blending ratio between the carboxy group-containing (meth)acrylic polymer and the amino group-containing (meth)acrylic polymer can be changed to impart the desired tensile strength and elongation properties to the thermoformed sheet. In an embodiment, as for the blending ratio between the high Tg (meth)acrylic polymer and the low Tg (meth)acrylic polymer of the carboxy group-containing (meth)acrylic polymer and the amino group-containing (meth)acrylic polymer, the blending ratio for the low Tg (meth)acrylic polymer is approximately 10 parts by mass or greater, approximately 20 parts by mass or greater, approximately 50 parts by mass or greater, or approximately 80 parts by mass or greater, and approximately 900 parts by mass or less, approximately 500 parts by mass or less, approximately 200 parts by mass or less, or approximately 150 parts by mass or less, based on 100 parts by mass of the high Tg (meth)acrylic polymer.

A total content of the carboxy group-containing (meth)acrylic polymer and amino group-containing (meth)acrylic polymer in the acrylic blend thermoplastic resin is typically approximately 25 mass % or greater, approximately 35 mass % or greater, or approximately 45 mass % or greater, and 100 mass % or less, approximately 90 mass % or less, or approximately 80 mass % or less.

Cross-linking between the carboxy group-containing (meth)acrylic polymers, or between the carboxy group-containing (meth)acrylic polymer and the amino group-containing (meth)acrylic polymer are preferable. The cross-linking leads to formation of a mesh structure, and then further improves the strength and elongation characteristics of the thermoformed sheet. Examples of the cross-linking agent for the carboxy group-containing (meth)acrylic polymers include epoxy cross-linking agents, bisamide cross-linking agents, aziridine cross-linking agents, and carbodiimide cross-linking agents. As the cross-linking agent, one or more types of cross-linking agents can be used, as necessary.

Examples of the epoxy cross-linking agents include N,N,N′,N′-tetraglycidyl-1,3-benzenedi(methanamine) (product name: TETRAD-X (Mitsubishi Gas Chemical Company Inc., Chiyoda-ku, Tokyo, Japan), E-AX, E-5XM (Soken Chemical & Engineering Co., Ltd., Toshima-ku, Tokyo, Japan)); and N,N′-(cyclohexane-1,3-diylbismethylene)bis(diglycidylamine) (product name: TETRAD-C (Mitsubishi Gas Chemical Company Inc., Chiyoda-ku, Tokyo, Japan), E-5C (Soken Chemical & Engineering Co., Ltd., Toshima-ku, Tokyo, Japan)). Examples of the bisamide cross-linking agent include 1,1′-(1,3-phenylenedicarbonyl)bis(2-methylaziridine), 1,4-bis(ethylenciminocarbonylamino)benzene, 4,4′-bis(ethyleneiminocarbonylamino)diphenylmethane, and 1,8-bis(ethyleneiminocarbonylamino)octane. Examples of the aziridine cross-linking agents include CHEMITITE PZ33 (Nippon Shokubai Co., Ltd., Osaka-shi, Osaka, Japan), and NeoCryl CX-100 (DSM Coating Resins, LLC., Zwolle, Provincie Overijssel, Netherlands). Examples of carbodiimide cross-linking agents include Carbodilite V-03, V-05, and V-07 (Nisshinbo Chemical Inc., Chuo-ku, Tokyo, Japan).

An amount of the cross-linking agent added can be approximately 0.01 parts by mass or greater, approximately 0.05 parts by mass or greater, or approximately 0.1 parts by mass or greater, and approximately 5 parts by mass or less, approximately 3 parts by mass or less, or approximately 2 parts by mass or less, with respect to 100 parts by mass of the carboxy group-containing (meth)acrylic polymer.

The polyurethane heat-sensitive adhesive agent contains a polyurethane that is a reactant of polyol and polyisocyanate. Examples of the polyol include high molecular weight polyols such as polyester polyols, polyether polyols, and polycarbonate polyols, and low molecular weight polyols having from 2 to 20 carbons such as ethylene glycol, 1,2-propane diol, 1,3-propane diol, 2-methyl-1,3-propane diol, 2-butyl-2-ethyl-1,3-propane diol, 1,3-butane diol, 1,4-butane diol, 1,5-pentane diol, 3-methyl-1,5-pentane diol, 1,6-hexane diol, neopentyl glycol, glycerin, diethylene glycol, trimethylene glycol, triethylene glycol, tetraethylene glycol, dipropylene glycol, tripropylene glycol, cyclohexane dimethanol, methylpentane diol adipate, trimethylol propane, and pentaerythritol. Examples of the polyisocyanate include aliphatic polyisocyanates such as 1,6-hexamethylene diisocyanate, 2,2,4-trimethylhexamethylene diisocyanate, 2,4,4-trimethylhexamethylene diisocyanate, and lysine diisocyanate; alicyclic polyisocyanates such as isophorone diisocyanate, trans and/or cis-1,4-cyclohexane diisocyanate, norbornene diisocyanate, and hydrogenated diphenylmethane diisocyanate; aromatic polyisocyanates such as 2,4-tolylene diisocyanate, 2,6-tolylene diisocyanate, 4,4′-diphenylmethane diisocyanate, 2,4′-diphenylmethane diisocyanate, and 2,2′-diphenylmethane diisocyanate; and biuret modified bodies, isocyanurate modified bodies, carbodiimide modified bodies, or adduct modified bodies of these. As the polyol or polyisocyanate, one type or two or more types of polyols or polyisocyanates can be used.

The polyurethane heat-sensitive adhesive agent preferably contains a linear polyurethane. The polyurethane may have a hydroxy group. The polyurethane having a hydroxy group can be obtained by reacting polyol and polyisocyanate in a manner that the NCO/OH ratio (number of moles of isocyanate groups in the polyisocyanate/number of moles of hydroxy groups in the polyol) is less than 1, i.e., in a manner that the amount of the hydroxy group is in excess.

From the perspective of suppressing heat shrinkage of the thermoformed sheet, the polyurethane heat-sensitive adhesive agent is preferably crosslinked. The cross-linking polyurethane heat-sensitive adhesive agent can be formed by reacting a polyurethane having a hydroxy group and the polyisocyanate as a cross-linking agent. Excess isocyanate groups of the polyisocyanate are also reacted with moisture contained in the air and the like and contribute to the crosslinking. The NCO/OH ratio of the polyurethane having a hydroxy group and the polyisocyanate as the crosslinking agent (number of moles of isocyanate groups in the polyisocyanate/number of moles of hydroxy groups of the polyurethane having a hydroxy group) can be, for example, approximately 0.5 or greater, approximately 1 or greater, or approximately 2 or greater, and approximately 10 or less, approximately 8 or less, or approximately 6 or less.

The melting point (Tm) of the polyurethane heat-sensitive adhesive agent before cross-linking can be approximately 30° C. or higher, approximately 35° C. or higher, or approximately 40° C. or higher, and approximately 80° C. or lower, approximately 65° C. or lower, or approximately 50° C. or lower. The melting point (Tm) of the polyurethane heat-sensitive adhesive agent is a value measured by using a differential scanning calorimeter.

The second adhesive layer may further contain a tackifier. Examples of the tackifier include rosin derivatives, terpene resin-based, petroleum resin-based, phenolic resin-based, and xylene resin-based tackifiers.

The heat-activated heat-sensitive adhesive layer may further contain a solid plasticizer. The solid plasticizer is solid at room temperature and melted when heated to its melting point or higher, and thus can swell or melt, for example, the polyurethane and the tackifier. By this, at high temperatures, tackiness of the heat-sensitive adhesive layer is increased. On the other hand, when the solid plasticizer is once melted, because crystallization progresses slowly even when the temperature is dropped lower than the melting point, tackiness caused by the heat activation can be maintained for a long time. Examples of the solid plasticizer include diphenyl phthalate, dihexyl phthalate, dicyclohexyl phthalate, dihydroabietyl phthalate, dimethyl isophthalate, sucrose benzoate, ethylene glycol dibenzoate, trimethylolethane tribenzoate, glyceride tribenzoate, sucrose octaacetate, tricyclohexyl citrate, and N-cyclohexyl-p-toluenesulfonamide.

The second adhesive layer may additionally contain, for example, ultraviolet absorbers such as benzotriazole, light stabilizers such as hindered amine, antioxidants such as phenolic antioxidants, silane coupling agents, cross-linking agents, fillers such as electrically conductive fillers and thermally conductive fillers, plasticizers other than the above-mentioned plasticizers, thickeners, pigments, dyes, flame retardants, and stabilizers as optional components.

The thickness of the second adhesive layer may vary, and, from the perspective of the adhesive force to the adherend (peel prevention properties) and opening resistance, is preferably approximately 10 micrometers or greater, approximately 15 micrometers or greater, approximately 20 micrometers or greater, approximately 25 micrometers or greater, approximately 30 micrometers or greater, or approximately 35 micrometers or greater, and preferably approximately 140 micrometers or less, preferably approximately 130 micrometers or less, approximately 120 micrometers or less, or approximately 110 micrometers or less, approximately 100 micrometers or less, or approximately 90 micrometers or less.

The second adhesive layer can be formed using, for example, a second adhesive composition containing the carboxy group-containing (meth)acrylic polymer, the amino group-containing (meth)acrylic polymer, the polyurethane, and, as necessary, a solvent and/or the cross-linking agent. Specifically, the second adhesive composition can be coated to a surface layer or a release liner such as a release-treated PET film, and dried, solidified or cured to form the second adhesive layer on the surface layer or release liner. Alternatively, a second adhesive composition can be coated on the first adhesive layer formed on the release liner and dried, solidified, or cured to form a second adhesive layer. As a coating device, an ordinary coater can be used, such as a bar coater, a knife coater, a roll coater, or a die coater. Drying, solidification or curing can be performed by drying the second adhesive composition including a volatile solvent, cooling the melted resin component, or the like. The second adhesive layer can also be formed by melt extrusion.

The second adhesive layer has a generally flat adhesive surface, but may include, for example, a surface with recesses and protrusions corresponding to the adhesive surface with recesses and protrusions of the first adhesive surface described above. The surface with recesses and protrusions of such a second adhesive layer can be obtained, for example, using a release liner having a release surface having a predetermined uneven structure, similarly to the first adhesive layer. For example, a release liner having a release surface having an uneven structure, which is larger than a thickness of the first adhesive layer, is prepared, and the first adhesive composition is applied to the release surface of the release liner, and heated as necessary to form the first adhesive layer. Next, the second adhesive composition is coated to the first adhesive layer on which the uneven structure of the release liner remains, and heated as necessary to form the second adhesive layer. As a result, the uneven structure (negative structure) of the release liner is transferred to the surface in contact with the first adhesive layer of the second adhesive layer, and the surface with recesses and protrusions having a predetermined structure (positive structure) is formed in the second adhesive layer.

The thermoformed sheet of the present disclosure includes a surface layer. The raw material of the surface layer is not particularly limited, and for example, one type of or a blend of two or more types of (meth)acrylic resins such as polymethyl methacrylate (PMMA) and (meth)acrylic copolymers, resins having a urethane bond (e.g., polyurethane), fluororesins such as ethylene-tetrafluoroethylene copolymers (ETFE), polyvinylidene fluoride (PVDF), methyl methacrylate-vinylidene fluoride copolymers (PMMA/PVDF), and tetrafluoroethylene-hexafluoropropylene-vinylidene fluoride copolymer (THV), silicone resins, polyvinyl chloride (PVC), polycarbonate (PC), polyolefins such as polyethylene (PE) and polypropylene (PP), polyesters such as polyethylene terephthalate (PET) and polyethylene naphthalate (PEN), polyamides such as nylon, and copolymers such as ethylene/acrylic acid copolymers (EAA) and ionomers thereof, ethylene-ethyl acrylate copolymers, ethylene-vinyl acetate copolymers, and ethylene-vinyl alcohol copolymers (EVOH) can be used. The surface layer may have a multilayer structure. For example, the surface layer may be a laminate of films formed from the resins described above, or may be a multilayer coating of the resins described above. The surface layer may have a three-dimensional uneven shape such as an emboss pattern on the entire or a part of the surface thereof. Here, in the present disclosure, the term “resin having a urethane bond” may include, for example, a resin prepared using at least one selected from urethane (meth)acrylate and urethane (meth)acrylate oligomer, and the urethane resin can also include a (meth)acrylic urethane resin, and the like.

The surface layer can be formed by coating the second adhesive layer with a resin composition directly or through a bonding layer or the like. The coating of the surface layer can be performed before application or after application of the thermoformed sheet to an adherend (e.g., supporting member described below). Alternatively, the surface layer film can be formed by coating a release liner with a resin composition, and the film can be laminated on the second adhesive layer directly or through a bonding layer or the like. For example, the surface layer film can be formed by coating a release liner with a resin material such as a curable (meth)acrylic resin composition or a reactive polyurethane composition by knife coating, bar coating, blade coating, doctor coating, roll coating, or cast coating, and then light or heat curing as necessary.

A surface layer formed into a film beforehand through extrusion, stretching, and the like may be used. Such a film can be laminated on the second adhesive layer directly or through a bonding layer or the like. By using a film with high flatness as such a film, an article (structure) can be given an appearance of higher surface flatness. The surface layer can be formed by multilayer extrusion with other layers. For example, a (meth)acrylic film can be used as the other layer. For example, a resin containing polymethyl methacrylate (PMMA), butyl polyacrylate, (meth)acrylic copolymer, ethylene/acrylic copolymer, ethylene vinyl acetate/acrylic copolymer can be formed into a film and used as the (meth)acrylic film. The (meth)acrylic film is excellent in transparency and/or scratch resistance, resistant to heat and/or light, and less likely to cause discoloration and/or changes in gloss. In addition, excellent molding processability is achieved without use of a plasticizer, and excellent contamination resistance is also achieved because use of plasticizer is not required. Among these, a (meth)acrylic film having PMMA as the main component is preferred. For example, in a case where a (meth)acrylic resin having excellent scratch resistance or the like is used as such another layer and a fluororesin having excellent chemical resistance or the like, such as ETFE, PVDF, or PMMA/PVDF, as the surface layer, the formed surface layer can be a surface layer having both performances of these layers.

The surface layer of the present disclosure can contain, for example, fillers, antioxidants, UV absorbing agents, light stabilizers, heat stabilizers, hard coat material, gloss-imparting agent, dispersants, plasticizers, flow improvers, surfactants, leveling agents, silane coupling agents, catalysts, pigments, and dyes as optional components in a range that does not impair the performance (e.g., protecting performance) based on the purpose. Among these, for example, use of UV absorbing agents such as benzotriazole, Tinuvin (trade name) 400 (available from BASF), and hindered amine light stabilizers (HALS) such as Tinuvin (trade name) 292 (available from BASF) can effectively prevent discoloration, fading, and deterioration of the layer located as a lower layer. The hard coat material may be contained in the surface layer, or may be applied as a hard coat layer by separately coating on the surface layer.

The surface layer may be transparent, translucent or opaque. When a decorative layer is included in the thermoformed sheet, the surface layer may be partially translucent or opaque. However, for example, from the perspective of visibility of decorative layer, the surface layer is preferably transparent.

The thickness of the surface layer may vary, and, for example, may be approximately 1 micrometer or greater, approximately 5 micrometers or greater, approximately 10 micrometers or greater, approximately 20 micrometers or greater, or approximately 30 micrometers or greater, and may be approximately 200 micrometers or less, approximately less than 200 micrometers, approximately 180 micrometers or less, approximately 150 micrometers or less, approximately 130 micrometers or less, approximately 100 micrometers or less, or approximately 80 micrometers or less. From the perspective of opening resistance, the thickness of the surface layer is preferably approximately less than 200 micrometers, or approximately 180 micrometers or less. When the thermoformed sheet is applied to a supporting member with a complex shape, from the perspective of shape followability, a thinner surface layer is more advantageous. For example, the thickness is preferably approximately 100 micrometers or less, or approximately 80 micrometers or less. In contrast, when high performance such as chemical resistance, weather resistance, or scratch resistance is imparted to an article, a thicker surface layer is more advantageous. For example, the thickness is preferably approximately 5 micrometers or greater, approximately 10 micrometers or greater, approximately 20 micrometers or greater, or approximately 30 micrometers or greater.

The thermoformed sheet of the present disclosure may optionally include an additional layer. Examples of such additional layers include at least one selected from the group consisting of decorative layers (e.g., color layers, pattern layers, and relief layers), bonding layers, middle film layers, and release liners. The additional layer can be applied to the entire surface or a portion of the thermoformed sheet, for example. The additional layer may have a three-dimensional shape such as an emboss pattern on its surface.

As optional components, the additional layer can contain, for example, tackifying resins, cross-linking agents, fillers such as electrically conductive fillers and thermally conductive fillers, silane coupling agents, plasticizers, thickeners, pigments, dyes, flame retardants, antioxidants, UV absorbing agents, stabilizers, dispersants, flow improvers, surfactants, and catalysts. These optional components can be used alone, or in combination of two or more types.

Examples of the decorative layer include, but are not limited to, a color layer that exhibits a paint color, for example, a light color, such as white and yellow, and a strong color, such as red, brown, green, blue, gray, and black; a pattern layer that imparts a design pattern (such as a wood grain, a stone grain, a geometric pattern, or a leather pattern), a logo, a picture pattern, or the like to an article; a relief (embossed pattern) layer in which an uneven shape is provided on the surface; and combinations of these layers.

The decorative layer can be applied to, but not limited to, the entire face of or a part of a layer constituting the thermoformed sheet, such as the surface layer, the first adhesive layer, or the second adhesive layer directly or through a bonding layer or the like.

The raw material for the color layer is not limited to the following, but for example, a raw material obtained by dispersing a pigment in a binder resin, such as a (meth)acrylic resin or a resin having a urethane bond, can be used. Examples of the pigment include inorganic pigments, such as carbon black, chrome yellow, yellow iron oxide, colcothar, or red iron oxide; or organic pigments, such as a phthalocyanine pigment such as phthalocyanine blue or phthalocyanine green, an azo lake pigment, an indigo pigment, a perinone pigment, a perylene pigment, a quinophthalone pigment, a dioxazine pigment, and a quinacridone pigment such as quinacridone red. Among these, for example, from the perspective of impact resistance, a resin having a urethane bond is preferred.

The color layer can be formed using such a raw material, for example, by a coating method, such as gravure coating, roll coating, die coating, bar coating, or knife coating.

The pattern layer is not limited to the following but, for example, a pattern layer obtained by directly applying a pattern, such as a design pattern, a logo, or a picture pattern, on the surface layer, the first adhesive layer, or the second adhesive layer, using a printing method, such as gravure direct printing, gravure offset printing, inkjet printing, laser printing, or screen printing, may be employed. Alternatively, for example, a film or a sheet having a design pattern, a logo, or a picture pattern, formed by coating, such as gravure coating, roll coating, die coating, bar coating, or knife coating, punching, or etching can be also used. For example, a raw material similar to those used in the color layer can be used for the pattern layer.

For the relief layer, a thermoplastic resin film having an uneven shape on the surface may be used, the uneven shape being obtained by a well-known method in the art, such as, for example, emboss finishing, scratch processing, laser processing, dry etching processing, or hot press processing. The relief layer can be also formed by applying a thermosetting or radiation-curable resin, such as a curable (meth)acrylic resin, on a release liner having an uneven shape, curing the resin by heat or radiation, and removing the release liner.

The thermoplastic resin, thermosetting resin, and radiation-curable resin used in the relief layer are not particularly limited but, for example, a fluororesin, a polyester resin such as PET or PEN, a (meth)acrylic resin, a polyolefin resin such as polyethylene or polypropylene, a thermoplastic elastomer, polycarbonate, polyamide, an ABS resin, an acrylonitrile-styrene resin, polystyrene, vinyl chloride, or a resin having a urethane bond can be used. Among these, for example, from the perspective of impact resistance, a resin having a urethane bond is preferred. The relief layer may contain at least one of the pigments used in the color layer.

The thickness of the decorative layer is only required to be appropriately adjusted according to the required decorativeness or the like and not particularly limited but, for example, can be approximately 1.0 micrometer or greater, approximately 3.0 micrometers or greater, or approximately 5.0 micrometers or greater, and can be approximately 50 micrometers or less, approximately 40 micrometers or less, or approximately 30 micrometers or less.

In the thermoformed sheet of the present disclosure, a bonding layer (sometimes referred to as “primer layer”, for example) can be used to bond each layer constituting the thermoformed sheet. In one embodiment, the thermoformed sheet has a bonding layer between the surface layer and the decorative layer or middle film layer, which is an optional element, or between the decorative layer and the middle film layer.

The bonding layer can contain, for example, a resin having a urethane bond, a (meth)acrylic resin, an epoxy resin, a phenoxy resin, or a resin blend of two or more types of these. In an embodiment, a bonding layer contains a resin blend of a resin having a urethane bond and a phenoxy resin.

The thickness of the bonding layer can be, for example, approximately 0.1 micrometers or greater, approximately 0.2 micrometers or greater, or approximately 0.5 micrometers or greater, and approximately 10 micrometers or less, approximately less than 10 micrometers, approximately 5.0 micrometers or less, approximately 2.0 micrometers or less, approximately 1.0 micrometers or less, approximately 0.5 micrometers or less, or approximately less than 0.5 micrometers.

The thermoformed sheet may optionally include, for example, a middle film layer interposed between the surface layer and the second adhesive layer, between the surface layer and the decorative layer, between the decorative layer and the second adhesive layer. The middle film layer can enhance the strength of the thermoformed sheet.

As the middle film layer, for example, resin films of resins having a urethane bond, polyvinyl chlorides, polyolefins such as polyethylene and polypropylene, polyesters such as polyethylene terephthalate and polybutylene terephthalate, (meth)acrylic polymers, or fluorochemical polymers can be used. The middle film layer preferably has thermoplasticity. In an embodiment, the middle film layer contains a water-based resin having a urethane bond.

The thickness of the middle film layer can be, for example, approximately 5.0 micrometers or greater, approximately 10 micrometers or greater, or approximately 15 micrometers or greater, and approximately 200 micrometers or less, approximately 100 micrometers or less, or approximately 50 micrometers or less.

In the thermoformed sheet of the present disclosure, a release liner can be typically applied to the first adhesive layer. Examples of the release liner include paper; a plastic material such as polyethylene, polypropylene, polyester (e.g., PET), and cellulose acetate; and paper coated with such a plastic material. These liners may have a surface that has been subjected to release treatment with a release agent such as silicone.

The thickness of the release liner, generally, can be approximately 5 micrometers or greater, approximately 15 micrometers or greater, or approximately 25 micrometers or greater, and can be approximately 500 micrometers or less, approximately 300 micrometers or less, or approximately 250 micrometers or less.

The thermoformed sheet of the present disclosure may be, for example, a sheet-like article or a roll body wound in a roll shape.

The thermoformed sheet can be produced, for example, using the following procedure. A second adhesive composition is prepared, then a second adhesive layer composition is coated to a thermoplastic resin film as a surface layer, and, as necessary, heated and dried to form a second adhesive layer. A first adhesive composition is prepared, and a first adhesive layer composition is coated to the second adhesive layer, and, as necessary, heated and dried to form a first adhesive layer. In this way, the thermoformed sheet can be obtained. The first adhesive layer may be protected by laminating a release liner on the first adhesive layer of the thermoformed sheet.

In the production of the thermoformed sheet, after the first adhesive layer and the second adhesive layer are formed on the release liner, a thermoplastic resin film may be brought into contact with the exposed surface of the second adhesive layer and heat-laminated as a surface layer, or a resin component of the surface layer may be melt-extruded onto the exposed surface of the second adhesive layer.

As another embodiment, the thermoformed sheet can be produced, for example, in the following procedure. A decorative layer composition is prepared and coated to the release liner and, as necessary, heated and dried to form a decorative layer. A middle film layer composition is prepared, then coated to the exposed face of the decorative layer, and, as necessary, heated and dried to form a middle film layer. A bonding layer composition is prepared, then coated to a carrier film, and as necessary, heated and dried to form a bonding layer. The exposed face of the bonding layer and the exposed face of the middle film layer are brought into contact and heat-laminated, and then the carrier film is removed. As the surface layer, a thermoplastic resin film is brought into contact with the exposed face of the bonding layer and heat-laminated. A second adhesive composition is prepared, and after the decorative layer is exposed by removing the release liner, the second adhesive layer composition is coated to the decorative layer and, as necessary, heated and dried to form a second adhesive layer. A first adhesive composition is prepared, and a first adhesive layer composition is coated to the second adhesive layer, and, as necessary, heated and dried to form a first adhesive layer. In this way, the thermoformed sheet can be obtained. The first adhesive layer may be protected by laminating a release liner on the first adhesive layer of the thermoformed sheet.

In the production of the thermoformed sheet, after the decorative layer is formed, the thermoplastic resin film may be brought into contact with the exposed surface of the decorative layer and heat-laminated as the surface layer without forming the middle film layer or the bonding layer, or the resin component of the surface layer may be melt-extruded onto the exposed surface of the decorative layer. In the production of the thermoformed sheet, the first adhesive layer and the second adhesive layer may be formed not on a decorative layer but on a release liner, and then an exposed surface of the decorative layer and an exposed face of the second adhesive layer may be brought into contact and laminated at room temperature or heat-laminated.

The total thickness of the thermoformed sheet except the thickness of the release liner can be, for example, approximately 30 micrometers or greater, approximately 80 micrometers or greater, or approximately 120 micrometers or greater, and can be approximately 600 micrometers or less, approximately 400 micrometers or less, or approximately 350 micrometers or less.

The thermoformed sheet of the present disclosure exhibits a tensile strength of approximately 3 N/50 mm or greater and approximately 240 N/50 mm or less when stretched to 200% at 95° C. When the thermoformed sheet further has such tensile strength, it is possible to improve the adhesive force to the adherend (peel prevention properties) and the opening resistance. Such tensile strength in the thermoformed sheet can be obtained, for example, by appropriately adjusting the form (e.g., film), thickness, or material of the surface layer, the form, thickness, or material of any additional layer (e.g., middle film layer), or the like. Here, in the present disclosure, the 200% stretching refers to a condition of the film that is stretched to a length of 200% (two-fold) when the film length before stretching is defined as 100%. Specific measurement conditions for the tensile strength in the present disclosure is as described in “4. Tensile strength at 200% elongation” in the examples.

The tensile strength of the thermoformed sheet when it is stretched to 200% at 95° C. can be approximately 5 N/50 mm or greater, approximately 7 N/50 mm or greater, or approximately 9 N/50 mm or greater, and can be approximately 220 N/50 mm or less, approximately 200 N/50 mm or less, approximately 180 N/50 mm or less, approximately 160 N/50 mm or less, approximately 140 N/50 mm or less, approximately 120 N/50 mm or less, approximately 100 N/50 mm or less, or approximately 80 N/50 mm or less.

In an embodiment, the thermoformed sheet of the present disclosure exhibits a tensile strength of approximately 1 N/50 mm or greater and approximately 140 N/50 mm or less when stretched to 200% at 120° C. When the thermoformed sheet further has such tensile strength, it is possible to further improve the adhesive force to the adherend (peel prevention properties) and the opening resistance. Such tensile strength in the thermoformed sheet can be obtained, for example, by appropriately adjusting the form (e.g., film), thickness, or material of the surface layer, the form, thickness, or material of any additional layer (e.g., middle film layer), or the like.

The tensile strength of the thermoformed sheet when it is stretched to 200% at 120° C. can be approximately 2 N/50 mm or greater, approximately 3 N/50 mm or greater, approximately 4 N/50 mm or greater, or approximately 5 N/50 mm or greater, and can be approximately 120 N/50 mm or less, approximately 100 N/50 mm or less, approximately 80 N/50 mm or less, approximately 60 N/50 mm or less, or approximately 50 N/50 mm or less.

In one embodiment, when the thermoformed sheet is heated to 165° C.±5° C., stretched by using a vacuum and pressure forming machine to 200% in terms of an area ratio with an area of the thermoformed sheet before stretching as 100%, bonded to a PC-ABS plate, and cut in a lattice-like manner with a 40 mm width, and after let stand for 144 hours at 95° C., the thermoformed sheet of the present disclosure has a cut opening (opening) of approximately 1.0 mm or less. The opening of the cut is preferably approximately 0.8 mm or less, and more preferably approximately 0.5 mm or less. The cut opening indicates heat resistance of the thermoformed sheet and specifically indicates heat shrinkage behavior of the thermoformed sheet. When the value for the cut opening is smaller, the thermoformed sheet is less likely to shrink even in a high temperature environment, and the adhesivity to an adherend and the appearance of the thermoformed sheet can be maintained at a higher level. Specific measurement conditions for the cut opening is as described in “3. Heat shrinkage” in the examples.

In an embodiment, when the thermoformed sheet is heated to 165° C.±5° C., stretched by using a vacuum and pressure forming machine to 200% in terms of an area ratio with an area of the thermoformed film before stretching as 100%, adhered to a PC-ABS plate, and cut into a strip with a 10 mm width, the thermoformed sheet has an adhesive force of approximately 6.4 N/10 mm or greater in 180 degree peel at a peeling rate of 200 mm/min at 23° C. The adhesive force is preferably approximately 6.8 N/10 mm or greater, and more preferably approximately 7.2 N/10 mm or greater. The adhesive force is smaller than the force required for cohesive failure of the adherend or the thermoformed sheet and is typically approximately 20 N/10 mm or less, or approximately 15 N/10 mm or less. Specific measurement conditions for the adhesive force is as described in “2. adhesive force” in the examples.

According to an embodiment of the present disclosure, an article having the thermoformed sheet described above adhered to a supporting member (adherend) is provided. Examples of such an article may include a substantially flat article before molding processing, the substantially flat article being formed by bonding the thermoformed sheet to a supporting member, such as a polycarbonate plate; or an article having a three-dimensional shape obtained by further molding such a substantially flat article; or an article having a three-dimensional shape obtained by bonding the thermoformed sheet to a supporting member having a shape, such as a curved face. In the present disclosure, the term “three-dimensional shape” typically means a three-dimensional shape in which the Z axis is added to a two-dimensional shape (a planar shape with only the X axis and the Y axis).

From the perspective of productivity and the like, the article having a three-dimensional shape is preferably produced by applying the thermoformed sheet described above to a supporting member having a three-dimensional shape. The thermoformed sheet is preferably applied to the supporting member by a Vacuum Thermoforming (VT) method or a Dual Vacuum Thermoforming (DVT) method from the perspective of obtaining an article with high accuracy. The thermoformed sheet of the present disclosure can be suitably used for vacuum molding or vacuum compressed air molding with stretching.

The supporting member is not particularly limited, and can include, for example, at least one selected from the group consisting of (meth)acrylic resin member (e.g., polymethyl methacrylate (PMMA) resin member), polycarbonate resin member (PC resin member), acrylonitrile-butadiene-styrene copolymer member (ABS member), PC-ABS member, and electrodeposition coating member. These components can be used alone, or in combination of two or more. Of these, from the perspective of adhesive force to the thermoformed sheet (peel prevention properties), opening resistance, and the like, the supporting member is preferably at least one selected from the group consisting of a PC-ABS member, and an electrodeposition coating member.

A primer treatment may be applied to the surface of the supporting member. However, since the primer treatment is generally the use of organic solvents, the work environment can be exacerbated, or dust can be attached to the primer treatment surface to produce an appearance defect. The thermoformed sheet of the present disclosure can exhibit excellent adhesive force (peel prevention properties) and opening resistance even when no primer treatment is applied to the surface of the supporting member as an adherend. Therefore, from the perspective of obtaining a good work environment and a good article appearance, it is advantageous that no primer treatment be applied to the surface of the supporting member.

In order to provide an intended appearance, the supporting member may be transparent, semitransparent, or opaque entirely or partially in a visible area.

The thickness of the supporting member is not particularly limited and, for example, can be approximately 0.2 mm or greater, approximately 0.5 mm or greater, approximately 1.0 mm or greater, or approximately 1.5 mm or greater, and can be approximately 3.0 mm or less, approximately 2.5 mm or less, or approximately 2.0 mm or less.

The article to which the thermoformed sheet of the present disclosure is applied can be used for various purposes. Examples of such purposes include signboards (e.g., internally illuminated signboards and externally illuminated signboards); signs (e.g., internally illuminated signs and externally illuminated signs); various interior or exterior articles such as interior or exterior articles for vehicles, such as automobiles, railways, aircrafts, and ships (e.g., roof members; pillar members; door trim members; instrument panel members; front members, such as hoods; bumper members; fender members; side sill members; and interior panel members); and building members (e.g., doors); electrical appliances, such as personal computers, smartphones, cellular phones, refrigerators, and air conditioners; stationery; furniture; desks; and various containers such as cans. Among these, the article to which the thermoformed sheet of the present disclosure is applied can be suitably used for interior or exterior articles for vehicles. Examples of the vehicles include: cars such as trucks, buses, and passenger cars; two-wheeled vehicles such as motorcycles and motor scooters; bicycles; trains; and ships such as pleasure boats, yachts, and motorboats.

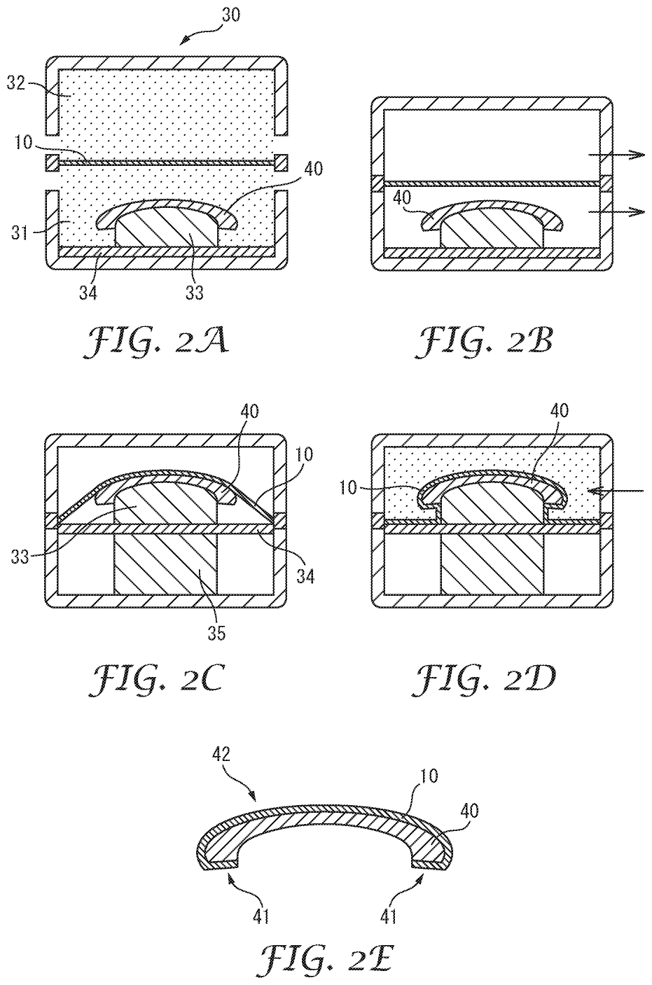

While referring to FIG. 2, a method of forming an article by applying a thermoformed sheet to a supporting member by using a dual vacuum thermoforming method (DVT method) will be described below as an example.

As illustrated in FIG. 2(A), an exemplary vacuum and pressure forming machine 30 has a first vacuum chamber 31 and a second vacuum chamber 32 on the bottom and top, respectively, and between these upper and lower vacuum chambers, has a jig on which is set the thermoformed sheet 10 to be bonded to the supporting member 40 serving as an adherend. A partition plate 34 and a pedestal 33 are disposed on a lift table 35 (not illustrated in FIG. 2(A)) capable of ascending and descending in the first vacuum chamber 31 on the bottom side, and the supporting member 40 such as a three-dimensional object or the like is set on this pedestal 33. As this type of vacuum and pressure forming machine, a commercially available product, for example, a two-sided vacuum molding machine (available from Fu-se Vacuum Forming Ltd.) may be used.

As illustrated in FIG. 2(A), the thermoformed sheet 10 is first set between the upper and lower vacuum chambers in a state in which the first vacuum chamber 31 and the second vacuum chamber 32 of the vacuum and pressure forming machine 30 are open to atmospheric pressure. The supporting member 40 is set on the pedestal 33 in the first vacuum chamber 31.

Next, as illustrated in FIG. 2(B), the first vacuum chamber 31 and the second vacuum chamber 32 are closed, the respective chambers are depressurized, and a vacuum (e.g., about 0 atm when atmospheric pressure is taken as 1 atm) is drawn inside each chamber. The thermoformed sheet is heated after or simultaneously with reduction of the pressure.

Next, as illustrated in FIG. 2(C), the lift table 35 is raised, and the supporting member 40 is pushed up to the second vacuum chamber 32. The heating can be performed, for example, by using an IR lamp heater (not illustrated) built into a ceiling part of the second vacuum chamber 32. The heating temperature generally may be about 50° C. or higher and about 180° C. or lower, and preferably about 130° C. or higher and about 160° C. or lower. The degree of vacuum of the vacuum atmosphere generally may be about 0.10 atm or less, about 0.05 atm or less, or about 0.01 atm or less, when atmospheric pressure is taken as 1 atm.

The heated thermoformed sheet 10 is pressed against the surface of the supporting member 40 and stretched. After that or at the same time, the interior of the second vacuum chamber 32 is pressurized to an appropriate pressure (e.g., from approximately 3 atm to approximately 1 atm), as illustrated in FIG. 2(D). Due to the pressure difference, the thermoformed sheet 10 firmly adheres to the exposed surface of the supporting member 40 and is expanded to conform to the three-dimensional shape of the exposed surface, thereby forming a covering firmly adhering to the surface of the supporting member. At least a portion of the thermoformed sheet 10 may be stretched approximately 4 times or more, approximately 4.5 times or more, or approximately 5 times or more, at the area ratio when stretched to conform the three-dimensional shape of the supporting member 40. After performing depressurization and heating in the state of FIG. 2(B), the interior of the second vacuum chamber 32 can be pressurized in that state, and the exposed surface of the supporting member 40 can be covered with the thermoformed sheet 10.

After this, the lower and upper first vacuum chamber 31 and second vacuum chamber 32 are again opened to atmospheric pressure, and the supporting member 40 covered with the thermoformed sheet 10 is removed. As illustrated in FIG. 2(E), the edges of the thermoformed sheet 10 firmly adhered to the surface of the supporting member 40 are trimmed, and the DVT process is complete. In this way, the thermoformed sheet 10 wraps around to the back surface 41 on the ends of the supporting member 40 and neatly covers the exposed surface, and thus an article 42 covered with a good wrapping can be obtained

### EXAMPLES

In the following examples, specific embodiments of the present disclosure will be illustrated, but the present invention is not limited to these examples. All ‘part’ and ‘percent’ are based on mass unless otherwise specified. A numerical value essentially includes an error originated from a measurement principle and a measuring device. The numerical value is generally indicated by a significant digit that is rounded.

### Synthesis of Carboxy Group-Containing (Meth)Acrylic Polymer (Polymer A)

A toluene/ethyl acetate mixed solution of polymer A (solid content: 33 mass %) was obtained by dissolving 94 parts by mass of n-butyl acrylate (BA) and 6 parts by mass of acrylic acid (AA) in a mixed solvent of 100 parts by mass of toluene and 100 parts by mass of ethyl acetate, adding 0.2 parts by mass of 2,2′-azobis(2,4-dimethylvaleronitrile) (trade name: V-65, FUJIFILM Wako Pure Chemical Corporation (Osaka-shi, Osaka, Japan)) as a polymerization initiator, and then reacting the mixture for 24 hours at 50° C. in a nitrogen atmosphere. The weight average molecular weight of the Polymer A was 760000, and the glass transition temperature (Tg) calculated from the FOX equation was −48° C.

### Synthesis of Amino Group-Containing (Meth)Acrylic Polymer (Polymer B)

An ethyl acetate solution of polymer B (solid content: 39 mass %) was obtained by dissolving 60 parts by mass of methyl methacrylate (MMA), 34 parts by mass of n-butyl methacrylate (BMA) and 6 parts by mass of dimethylaminoethyl methacrylate (DMAEMA) in 150 parts by mass of ethyl acetate, adding 0.6 parts by mass of dimethyl-2,2′-azobis(2-methylpropionate) (trade name: V-601, FUJIFILM Wako Pure Chemical Corporation (Osaka-shi, Osaka, Japan)) as a polymerization initiator, and then reacting the mixture for 24 hours at 65° C. in a nitrogen atmosphere. The weight average molecular weight of the Polymer B was 68000. and the glass transition temperature (Tg) calculated from the FOX equation was 63° C.

The products used in this example are shown in Table 1 below.

TABLE 1

| Trade name, model | | | Solid | |
|---|---|---|---|---|
| number, or | | Tg | content | |
| abbreviated name | Description | (° C.) | [wt %] | Manufacturer |
| TRIXENE (trade | A block isocyanate polymer that is a burette of 1,6- | — | 70.0 | Baxenden Chemicals |
| name) BI 7960 | hexamethylene diisocyanate blocked with 3,5-dimethylpyrazole, | | | Limited |
| | a dissociation temperature: 110 to 120° C., NCO equivalent | | | (Baxenden, UK) |
| | weight: 410 | | | |
| TRIXENE (trade | 3,5-dimethylpyrazole, blocked isocyanate polymer, which is a | — | 65.0 | Baxenden Chemicals |
| name) BI 7951 | trimer of isophorone diisocyanate, dissociation temperature: 110 | | | Limited |
| | to 120° C., NCO equivalent weight: 539 | | | Baxenden, UK) |
| NIPPOLAN (trade | Polyurethane resin for adhesives, ethyl acetate solution | — | 50.0 | Tosoh Corporation |
| name) 3124 | | | | (Minato-ku, Tokyo, Japan) |
| Polymer A | Carboxy group-containing (meth)acrylic polymer, BA/AA = | −48 | 33.0 | — |
| | 94/6 (mass ratio), weight average molecular weight: 760,000, | | | |
| | toluene/ethyl acetate solution | | | |
| Polymer B | Amino group-containing (meth)acrylic polymer, | 63 | 39.0 | — |
| | MMA/BMADMAEMA = 60/34/6 (mass ratio), weight average | | | |
| | molecular weight: 68,000 Ethyl acetate solution | | | |
| E-5XM | Epoxy-based crosslinking agent | — | 5.0 | Soken Chemical & |
| | | | | Engineering Co., Ltd. |
| | | | | (Toshima-ku, Tokyo, Japan) |
| Desmocoll (trade | Polyurethane heat-sensitive adhesive agent | — | 20.0 | Sumika Covestro Urethane |
| name) 530 | | | | Co., Ltd. |
| | | | | (Amagasaki-shi, Hyogo, |
| | | | | Japan) |
| Coronate (trade name) | Polyisocyanate-based cross-linking agent | — | 70.0 | Tosoh Corporation |
| HL | | | | (Minato-ku, Tokyo, Japan) |
| MIBK | Methyl isobutyl ketone | — | — | KH Neochem Co., Ltd. |
| | | | | (Chuo-ku, Tokyo, Japan) |
| Technolloy (trade | Polymethyl methacrylate (PMMA) resin film | — | — | Sumika Acryl Co., Ltd. |
| name) S014G | | | | (Chuo-ku, Tokyo, Japan) |
| ACRYPRENE (trade | Two-layer film of a mixed layer of polyvinylidene fluoride | — | — | Mitsubishi Chemical |
| name) FBA015 | (PVDF) and PMMA/PMMA layer | | | Corporation |
| | | | | (Chiyoda-ku, Tokyo, Japan) |
| Technolloy (trade | Polycarbonate (PC) resin film | — | — | Sumika Acryl Co., Ltd. |
| name) C000 | | | | (Chuo-ku, Tokyo, Japan) |
| Panlite (trade name) | Polycarbonate (PC) resin film | — | — | Teijin Limited |
| PC-2151 | | | | (Chiyoda-ku, Tokyo, Japan) |
| Dyneon (trade name) | Tetrafluoroethylene-hexafluoropropylene-vinylidene fluoride | — | — | 3M Japan Limited |
| THV221G | copolymer (THV) | | | (Shinagawa-ku, Tokyo, |
| | | | | Japan) |

### Comparative Example 1

A two-layer structured thermoformed sheet was prepared by the following procedures. A second adhesive composition E1 in Table 3 was applied using a knife coater on a 75 micrometer thick Technolloy (trade name) S014G as a surface layer, and placed in a hot air oven at 80° C. for 10 minutes to form a second adhesive layer having a thickness of 40 micrometers, to thereby obtain a thermoformed sheet of Comparative Example 1 without the first adhesive layer.

### Example 1

A three-layer structured thermoformed sheet was prepared by the following procedures. The second adhesive composition E1 in Table 3 was applied using a knife coater on a 75 micrometer thick Technolloy (trade name) S014G constituting a surface layer, and placed in a hot air oven at 80° C. for 10 minutes to form a second adhesive layer having a thickness of 40 micrometers.

The first adhesive composition E1 in Table 2 was applied on the second adhesive layer using a knife coater, and placed in a hot air oven at 80° C. for 10 minutes to form a first adhesive layer having a thickness of 1.0 micrometers, to thereby obtain a thermoformed sheet of Example 1.

### Examples 2 to 4, Examples 9 to 11, and Comparative Example 2

Thermoformed sheets of Example 2 to Example 4, Example 9 to Example 11, and

Comparative Example 2 were obtained in the same procedure as in Example 1 except that the thickness of the first adhesive layer and/or the second adhesive layer was as shown in Table 5.

### Example 5, Comparative Example 3, Comparative Example 5, and Comparative Example 6

Thermoformed sheets of Example 5, Comparative Example 3, Comparative Example 5, and Comparative Example 6 were obtained in the same procedure as in Example 3 except that the first adhesive composition used was E2, C1, C2, or C3 in Table 2.

### Example 6 to Example 8, Comparative Example 7, and Comparative Example 8

Thermoformed sheets of Example 6 to Example 8, Comparative Example 7, and Comparative Example 8 were obtained in the same procedure as in Example 3 except that the surface layer used was as shown in Table 5.

### Example 12

A thermoformed sheet produced by the same procedure as in Example 3 was stored in an environment at 23° C. 60% RH for 40 days to obtain a thermoformed sheet of Example 12.

### Comparative Example 4

A two-layer structured thermoformed sheet was prepared by the following procedures. The first adhesive composition E1 in Table 2 was applied using a knife coater on a 75 micrometer thick Technolloy (trade name) S014G as a surface layer, and placed in a hot air oven at 80° C. for 10 minutes to form a first adhesive layer having a thickness of 5.0 micrometers, to thereby obtain a thermoformed sheet of Comparative Example 4 without the second adhesive layer.

TABLE 2
First adhesive composition

| | Solid content | | | | | |
|---|---|---|---|---|---|---|
| Component | (%) | E1 | E2 | C1 | C2 | C3 |
| TRIXENE | 70.0 | 20.0 | 16.0 | — | 12.0 | 6.0 |
| (trade name) | | | | | | |
| B1 7960 | | | | | | |
| TRIXENE | 65.0 | — | — | 20.0 | — | — |
| (trade name) | | | | | | |
| BI 7951 | | | | | | |
| NIPPOLAN | 50.0 | — | 5.6 | — | 11.2 | 19.6 |
| (trade name) 3124 | | | | | | |
| Ethyl acetate | 0.0 | 80.0 | 78.4 | 80.0 | 76.8 | 74.4 |

| | | | | | |
|---|---|---|---|---|---|
| Total | 100 | 100 | 100 | 100 | 100 |

TABLE 3
Second adhesive composition

| Component | Solid content (%) | E1 | E2 |
|---|---|---|---|
| Polymer A | 33.0 | 40.0 | — |
| Polymer B | 40.0 | 14.4 | — |
| MIBK | — | 25.2 | — |
| E-5XM | 30.0 | 0.4 | — |
| Desmocoll (trade name) 530 | 100 | — | 17.9 |
| MEK | — | — | 71.7 |
| Coronate (trade name) HL | 70.0 | — | 0.39 |
| Black paint | 30.1 | 20.0 | 10.0 |

| | | |
|---|---|---|
| Total | 100 | 100 |

TABLE 4
Black paint

| Component | Solid content(%) | mass % |
|---|---|---|
| Acryl polyol | 100 | 19.8 |
| Xylene | — | 4.4 |
| Ethyl benzene | — | 3.6 |
| Carbon black | 100 | 2.9 |
| n-Butyl acetate | — | 14.4 |
| Isobutyl acetate | — | 5.4 |
| Cellulose acetate butyrene | 100 | 6.3 |
| Zirconium oxide | 100 | 0.1 |
| Titanium dioxide | 100 | 0.5 |
| Toluene | — | 6.8 |
| Propylene glycol monomethyl ether acetate | — | 14.1 |
| Methyl ethyl ketone | — | 14.4 |
| Methoxybutyl acetate | — | 6.8 |
| Di-2-ethylhexyl sebacate | 100 | 0.5 |

| | |
|---|---|
| Total | 100 |

The thermoformed sheet was evaluated for the following items.

### 1. DVT Moldability

The following materials were used as the supporting member.

### A. PC-ABS Plate

A 150 mm×150 mm square PC-ABS plate test panel having a thickness of 3 mm (product name “flat plate test piece”, Black PC-ABS resin CK43 available from Techno Polymer Co., Ltd., MC Yamasan Polymers Co., Ltd. (Chuo-ku, Tokyo, Japan)) was cut into a 70 mm×150 mm rectangular shape, and the obtained product was used as a supporting member.

### B. Electrodeposition-Coated Steel Plate

A 70 mm×150 mm black cation electrodeposition-coated steel plate having a thickness of 1 mm (JIS, G, 3141 (SPCC, SD), Testpiece K.K. (Sagamihara-shi, Kanagawa, Japan)) was used as a supporting member.

Using the DVT method, the thermoformed sheet was stretched to 200% in terms of area ratio and bonded to the supporting member by the following procedure.

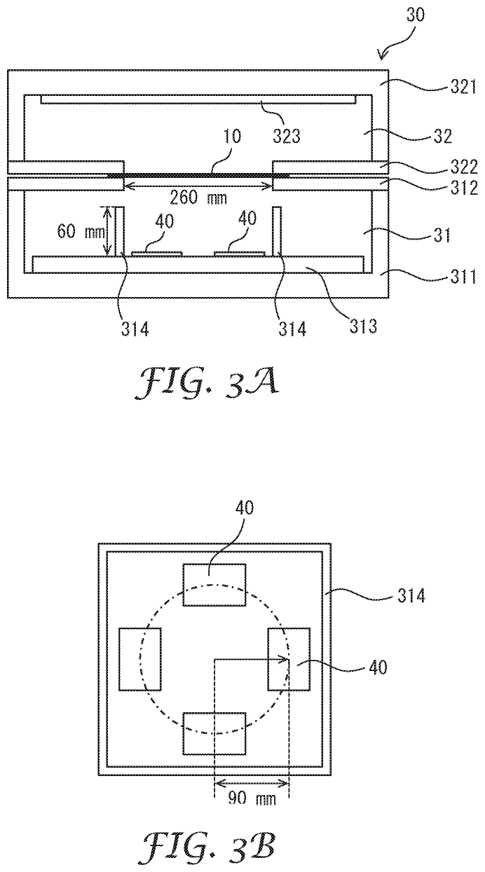

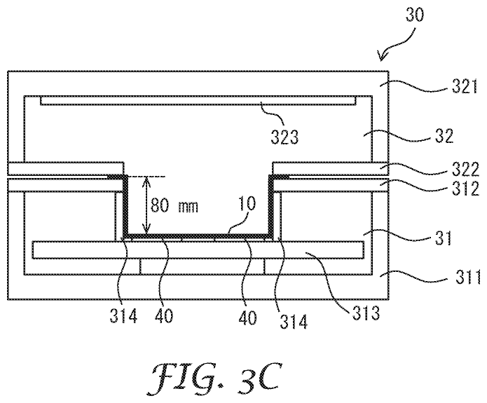

As the vacuum and pressure forming machine, a two-sided vacuum molding machine NGF0709 (Fu-se Vacuum Forming Ltd. (Habikino-shi, Osaka, Japan)) was used. FIG. 3A shows a schematic cross-sectional view of a vacuum and pressure forming machine before stretching. A first vacuum chamber 31 and a second vacuum chamber 32 of a vacuum and pressure forming machine 30 was separated by a bottom pot 311, a bottom pot frame 312, an upper pot 321, an upper pot frame 322, and a thermoformed sheet 10 that was sandwiched between the bottom pot frame 312 and the upper pot frame 322. For the ceiling part of the second vacuum chamber 32, an IR lamp heater 323 for heating was attached on the inner wall of the upper pot 321. The opening portion of the bottom pot frame 312 was a 260 mm×260 mm square.

On a bottom pot table 313 disposed on the bottom portion of the bottom pot 311, a well-type jig for stretching 314 having an internal dimension that was identical to the size of the opening portion of the bottom pot frame 312 and having a square tube shape with the top and bottom opened was disposed. The height of the well-type jig for stretching 314 was 60 mm, and it was confirmed in advance that the thermoformed sheet 10 was bonded to a supporting member 40 in a state where the thermoformed sheet 10 was stretched to 200% in terms of area ratio.

The supporting members 40 having a 70 mm×150 mm rectangular shape were set to the positions which were on the bottom pot table 313 and inside of the well-type jig for stretching 314 and which were confirmed in advance that the thermoformed sheet 10 was able to be bonded to the supporting member 40 in a state where the thermoformed sheet 10 was stretched to 200% in terms of area ratio. FIG. 3B shows a top view illustrating the arrangement position of the substrate. As illustrated in FIG. 3B, the supporting members 40 were disposed in a manner that the centers thereof were positioned at 4 locations that were 90 mm distanced from the center of the well-type jig for stretching 314. The circle indicated by a dot-and-dash line in FIG. 3B illustrates the position at which the thermoformed sheet 10 in a state where the thermoformed sheet 10 was stretched to 200% in terms of area ratio is bonded to the supporting members 40.

The thermoformed sheet 10 was cut to a 300 mm×300 mm square and disposed on the bottom pot frame 312. The thickness of the bottom pot frame 312 was 20 mm. Thus, the distance between the thermoformed sheet 10 and the supporting member 40 was 80 mm, which was the total of the thickness of the bottom pot frame 312 (20 mm) and the height of the well-type jig for stretching 314 (60 mm).

After the supporting member 40 and the thermoformed sheet 10 were set, the upper pot 321 and the upper pot frame 322 were lowered, and the thermoformed sheet 10 placed on the bottom pot frame 312 was sandwiched between the upper pot frame 322 and the bottom pot frame 312. Thereafter, while the pressure inside of the first vacuum chamber 31 and the second vacuum chamber 32 was reduced, the thermoformed sheet 10 was heated to 165° C.±5° C., which was the molding temperature, by the IR lamp heater 323. At this time, the vacuum condition (from 2 to 4 kPa) was achieved before the temperature reached at the molding temperature. The molding temperature was a value obtained based on the set temperature of the vacuum and pressure forming machine 30 and a corresponding relationship of the set temperature of the vacuum and pressure forming machine 30 and the actual temperature of the thermoformed sheet 10 obtained in advance by the procedure described below.

The DVT molding was started at the time when the molding temperature was reached. The bottom pot table 313 was raised until the well-type jig for stretching 314 was in touch with the bottom pot frame 312. By setting the internal pressure of the second vacuum chamber 32 to 200 to 205 kPa while the vacuum condition inside the first vacuum chamber 31 was maintained, a pressure difference was caused between the first vacuum chamber 31 and the second vacuum chamber 32, and by this the thermoformed sheet 10 was bonded to the supporting member 40 while the thermoformed sheet 10 was stretched. FIG. 3C shows a schematic cross-sectional view of a vacuum and pressure forming machine after stretching. In the center portion of the supporting member 40, the thermoformed sheet 10 was bonded in a state where the thermoformed sheet 10 was stretched to 200% in terms of area ratio.

After the inside of the first vacuum chamber 31 and the second vacuum chamber 32 was each returned to the atmospheric pressure, the supporting member 40 to which the stretched thermoformed sheet 10 was bonded was taken out. Excess portions of the thermoformed sheet 10 were trimmed along the edge of the supporting member 40 by using a utility knife, and thus an evaluation sample of DVT moldability was obtained.

It is known that, in general, there is a difference between the set temperature of the vacuum and pressure forming machine and the actual temperature of the thermoformed sheet heated inside the vacuum and pressure forming machine. Therefore, in this example, the corresponding relationship between the set temperature of the vacuum and pressure forming machine and the actual temperature of the thermoformed sheet was determined in advance, and the actual temperature of the thermoformed sheet during the DVT molding was taken as a value that was obtained based on the set temperature of the vacuum and pressure forming machine and the corresponding relationship described above.

The measurement of the actual temperature of the thermoformed sheet during the DVT molding was performed by using a temperature and voltage measurement unit NR-TH08 and a multiple-input data logger NR-500 (both from Keyence Corporation (Osaka-shi, Osaka, Japan)) and a thermocouple (Symbol: 0.1×1P K-2-H-J2 (K-H), wire: K type, Ninomiya Electric Wire Co., Ltd. (Sagamihara-shi, Kanagawa, Japan)).

The thermocouple was bonded to a surface of the thermoformed sheet 10 by a heat-resistant tape in a manner that the metal part of the thermocouple, which was the measurement point, was not in contact with the thermoformed sheet 10. The thermoformed sheet 10 was set on the bottom pot frame 312 in a manner that the surface to which the thermocouple was bonded was facing up.

The upper pot 321 and the upper pot frame 322 were lowered, and the thermoformed sheet 10 placed on the bottom pot frame 312 was sandwiched between the upper pot frame 322 and the bottom pot frame 312. Thereafter, the thermoformed sheet 10 was heated by the IR lamp heater 323. The set temperature of the vacuum and pressure forming machine at the time when the measured value of the thermocouple became 165±5° C. was 145° C. Based on this corresponding relationship, by setting the set temperature of the vacuum and pressure forming machine to 145° C. during the DVT molding, it was considered that the thermoformed sheet 10 was heated to 165±5° C.

### 2. Adhesive Force

The test piece adhered in the same condition as for the DVT moldability was cut into a strip form with a width of 10 mm, and the adhesive force was measured for 180 degree peeling at a peeling rate of 200 mm/min at a temperature of 23° C., using a tensile tester (Tensilon (trade name) universal tester, model number: RTC-1210A, A&D Company, Limited (Toshima-ku, Tokyo, Japan)). The measurement was performed two times to determine the average. For example, for the purpose of paint replacement of automobile exterior, the adhesive force of 6.4 N/10 mm or greater is required to be achieved.

### 3. Heat Shrinkage

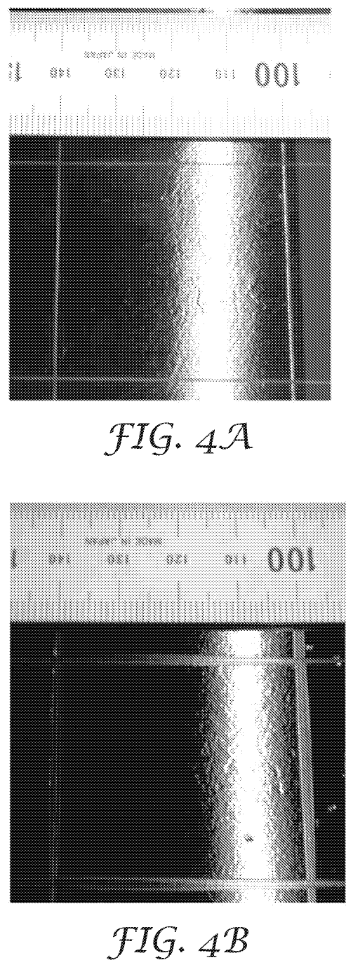

In the center of the test piece adhered in the same condition as for the DVT moldability, cuts were made in a lattice-like manner with a 40 mm width as illustrated in FIG. 4 and allowed to stand at 95° C. for 144 hours (6 days). The opening of the cut was measured at 4 positions, and the average of the measured value at the 4 positions was used as an index of heat shrinkage. The cut opening (opening) of 1.0 mm or less was evaluated as pass, and the cut opening of more than 1.0 mm was evaluated as fail.

### 4. Tensile Strength at 200% Elongation

Kapton (trade name) films having a width of 50 mm were bonded to both surfaces of a thermoformed sheet cut into a length of approximately 100 mm and a width of 50 mm at an interval of 50 mm in the length direction, thereby preparing a measurement sample in which two short sides of the thermoformed sheet were sandwiched by the Kapton (trade name) films. With a chuck interval of 55 mm for a tensile tester (Tensilon (trade name) universal tester, model number: RTC-1210A, A&D Company, Limited (Toshima-ku, Tokyo, Japan)), the measurement sample was fixed in such a way that the Kapton (trade name) film was brought into contact with the chuck. A constant-temperature bath was disposed to cover the entire chuck, and the measurement was started when the temperature indication inside the constant-temperature bath reached 95° C. or 120° C., and the tensile strength when the thermoformed sheet was stretched to 200% elongation (twice the original length) at the temperature of 95° C. or 120° C. and the tensile speed of 300 mm/min was measured. The measurement was performed two times at each temperature to determine the average.

The evaluation results of the thermoformed sheets are shown in Table 5. Here, in the layer structure, “A” means a layer structure of the first adhesive layer/second adhesive layer/film (surface layer). “B” means a layer structure of the second adhesive layer/film (surface layer). and “C” means a layer structure of the first adhesive layer/film (surface layer).

TABLE 5

| First adhesive layer | | | |
|---|---|---|---|
| Content of | | | Tensile |
| acyclic | | | strength |
| aliphatic | | | at 200% |
| isocyanate | Second adhesive layer | Film | elongation |

| | Layer | polymer | Thickness | | Thickness | | Thickness | at 95° C. |
|---|---|---|---|---|---|---|---|---|
| | Structure | (mass %) | (μm) | Type | (μm) | Type | (μm) | (N/50 mm) |
| Example 1 | A | 100 | 1.0 | Acrylic | 40 | S014G | 75 | 40.4 |
| Example 2 | A | 100 | 2.0 | Acrylic | 40 | S014G | 75 | 40.4 |
| Example 3 | A | 100 | 5.0 | Acrylic | 40 | S014G | 75 | 40.4 |
| Example 4 | A | 100 | 10 | Acrylic | 40 | S014G | 75 | 40.4 |
| Example 5 | A | 80 | 5.0 | Acrylic | 40 | S014G | 75 | 40.4 |
| Example 6 | A | 100 | 5.0 | Acrylic | 40 | FBA015 | 75 | 9.3 |
| Example 7 | A | 100 | 5.0 | Acrylic | 40 | C000 | 50 | 66.5 |
| Example 8 | A | 100 | 5.0 | Acrylic | 40 | PC-2151 | 125 | 169.3 |
| Example 9 | A | 100 | 5.0 | Acrylic | 20 | S014G | 75 | 40.4 |
| Example 10 | A | 100 | 5.0 | Acrylic | 80 | S014G | 75 | 40.4 |
| Example 11 | A | 100 | 5.0 | Urethane- | 20 | S014G | 75 | 40.4 |
| | | | | based | | | | |
| Example 12 | A | 100 | 5.0 | Acrylic | 40 | S014G | 75 | 40.4 |
| Comparative | B | — | — | Acrylic | 40 | S014G | 75 | 40.4 |
| Example 1 | | | | | | | | |
| Comparative | A | 100 | 15 | Acrylic | 40 | S014G | 75 | 40.4 |
| Example 2 | | | | | | | | |
| Comparative | A | (Cyclic | 5.0 | Acrylic | 40 | S014G | 75 | 40.4 |
| Example 3 | | aliphatic | | | | | | |
| | | 100 | | | | | | |
| | | mass %) | | | | | | |
| Comparative | C | 100 | 5.0 | Acrylic | 40 | S014G | 75 | 40.4 |
| Example 4 | | | | | | | | |
| Comparative | A | 60 | 5.0 | Acrylic | 40 | S014G | 75 | 40.4 |
| Example 5 | | | | | | | | |
| Comparative | A | 30 | 5.0 | Acrylic | 40 | S014G | 75 | 40.4 |
| Example 6 | | | | | | | | |
| Comparative | A | 100 | 5.0 | Acrylic | 40 | THV221G | 50 | 1.2 |
| Example 7 | | | | | | | | |
| Comparative | A | 100 | 5.0 | Acrylic | 40 | PC-2151 | 200 | 266 |
| Example 8 | | | | | | | | |

| | Tensile | | | | | | |
|---|---|---|---|---|---|---|---|
| | strength at | | | | Adherend | | |
| | 200% | Adherend (PC-ABS plate) | | | (electrodeposition-coat steel plate) | | |
| | elongation | | Adhesive | Heat | | Adhesive | Heat |
| | at 120° C. | DVT | force | shrinkage | DVT | force | shrinka |
| | (N/50 mm) | moldability | (N/10 mm) | (mm) | moldability | (N/10 mm) | (mm) |
| Example 1 | 21.5 | No defect | 7.5 | 0.5 | No defect | 8.5 | 0.6 |
| Example 2 | 21.5 | No defect | 8.7 | 0.4 | No defect | 9.6 | 0.4 |
| Example 3 | 21.5 | No defect | 9.5 | 0.2 | No defect | 11 | 0.2 |
| Example 4 | 21.5 | No defect | 9.7 | 0.2 | No defect | 9.0 | 0.3 |
| Example 5 | 21.5 | No defect | 7.3 | 0.8 | No defect | 14 | 1.0 |
| Example 6 | 3.3 | No defect | 10 | 0.2 | No defect | 11 | 0.2 |
| Example 7 | 44.2 | No defect | 9.9 | 0.3 | No defect | 12 | 0.3 |
| Example 8 | 113.6 | No defect | 13 | 0.7 | No defect | 14 | 0.8 |
| Example 9 | 21.5 | No defect | 6.8 | 0.2 | No defect | 7.1 | 0.2 |
| Example 10 | 21.5 | No defect | 12 | 0.9 | No defect | 13 | 1.0 1 |
| Example 11 | 21.5 | No defect | 7.5 | 0.3 | No defect | 8.4 | 0.2 |
| Example 12 | 21.5 | No defect | 8.3 | 0.2 | No defect | 11 | 0.2 |
| Comparative | 21.5 | No defect | 5.0 | 0.6 | No defect | 2.6 | 0.8 |
| Example 1 | | | | | | | |
| Comparative | 21.5 | Bubble | 5.6 | 0.2 | Bubble | 6.8 | 0.3 |
| Example 2 | | | | | | | |
| Comparative | 21.5 | No defect | 1.3 | 0.5 | No defect | 0.6 | 0.4 |
| Example 3 | | | | | | | |
| Comparative | 21.5 | No defect | 0.1 | 0.3 | Non- | — | — |
| Example 4 | | | | | adhesive | | |
| Comparative | 21.5 | No defect | 9.2 | 1.5 | No defect | 14 | 2.1 |
| Example 5 | | | | | | | |
| Comparative | 21.5 | No defect | 7.4 | 2.6 | No defect | 7.8 | 3.9 |
| Example 6 | | | | | | | |
| Comparative | 0.4 | No defect | 4.9 | 0.2 | No defect | 1.3 | 0.2 |
| Example 7 | | | | | | | |
| Comparative | 177 | No defect | 15 | 1.5 | No defect | 17 | 2.0 |
| Example 8 | | | | | | | |

Various variations of the above-mentioned embodiments and examples will be apparent to those skilled in the art without departing from the basic principle of the present invention. In addition, it is apparent for a person skilled in the art that various modifications and variations of the present invention can be made without departing from the spirit and scope of the present invention.

### REFERENCE SIGNS LIST

10 Thermoformed sheet
12 Surface layer
14 Second adhesive layer
16 First adhesive layer
20 Release liner
30 Vacuum and pressure forming machine
31 First vacuum chamber
311 Bottom pot
312 Bottom pot frame
313 Bottom pot table
314 Well-type jig for stretching
32 Second vacuum chamber
321 Upper pot
322 Upper pot frame
323 IR lamp heater
33 Pedestal
34 Partition plate
35 Lift table
40 Supporting member
41 Back surface
42 Article

1. A thermoformed sheet comprising a first adhesive layer, a second adhesive layer, and a surface layer in this order, wherein
the first adhesive layer comprises 65 mass % or greater, in terms of solid content ratio, of an acyclic aliphatic isocyanate polymer blocked with a blocking agent that starts to dissociate at lower than 160° C., and has a thickness of 0.5 micrometers or greater and 13 micrometers or less, and
the thermoformed sheet has a tensile strength of 3 N/50 mm or greater and 240 N/50 mm or less when stretched to 200% at 95° C.

2. The thermoformed sheet according to claim 1, wherein the acyclic aliphatic isocyanate polymer is a polymer in which a polymer of an acyclic aliphatic isocyanate compound is blocked with the blocking agent, and the acyclic aliphatic isocyanate compound is at least one selected from the group consisting of 1,6-hexamethylene diisocyanate and modified compounds thereof.

3. The thermoformed sheet according to claim 1, wherein the thermoformed sheet has a tensile strength of 1 N/50 mm or greater and 140 N/50 mm or less when stretched to 200% at 120° C.

4. The thermoformed sheet according to claim 1, wherein the second adhesive layer is a heat-sensitive adhesive layer.

5. The thermoformed sheet according to claim 1, wherein a thickness of the second adhesive layer is 10 micrometers or greater and 140 micrometers or less.

6. The thermoformed sheet according to claim 1, wherein
when the thermoformed sheet is heated to 165° C.±5° C., stretched by using a vacuum and pressure forming machine to 200% in terms of an area ratio with an area of the thermoformed sheet before stretching as 100%, bonded to a PC-ABS plate, and cut in a lattice-like manner with a 40 mm width, and after let stand for 144 hours at 95° C., the thermoformed sheet has a cut opening of 1.0 mm or less.

7. An article comprising the thermoformed sheet described in claim 1, the thermoformed sheet being adhered to a supporting member.

8. The article according to claim 7, wherein the article has a three-dimensional shape.

9. The article according to claim 7, wherein the article is an interior article or exterior article of a vehicle.

10. The article according to any one of claims 7, wherein the supporting member is at least one selected from the group consisting of a PC-ABS member and an electrodeposition coating member.
